(19) United States
(12) Patent Application Publication
(10) Pub. No.: US 2005/0229218 A1
(43) Pub. Date: Oct. 13, 2005

(54) Cable television system and method for providing cable television service by radio

(76) Inventors: Yuji Murao, Tama-shi (JP); Hirokazu Okita, Ayase-shi (JP); Masayuki Fujise, Ebina-shi (JP); Fumihide Kojima, Yokohama-shi (JP)

Correspondence Address: PEARNE & GORDON LLP, 1801 EAST 9TH STREET, SUITE 1200, CLEVELAND, OH, 44114-3108, US

(21) Appl. No.: 10/504,952

(22) PCT Filed: Feb. 18, 2003
(86) PCT No.: PCT/JP03/01691

§ 371 Date: Apr. 25, 2005

(30) Foreign Application Priority Data
Feb. 18, 2002 (JP) 2002-040337

(51) Int. Cl. H04N 5/445; H04H 9/00; G06F 13/00; G06F 3/00; H04N 7/16; H04N 7/173

(52) U.S. Cl. 725/81; 725/80; 725/46; 725/111; 725/100

(57) ABSTRACT

A cable television system 100 according to the present invention comprises: non-subscriber station devices 400 and 500 having accounting servers 450 and 550, respectively, for each acquiring a delivery historical file having a set of delivery historical information representative of a history of delivering contents from the other non-subscriber station device which has been just before connected to a CATV mobile terminal device 200, to store the acquired delivery historical file therein, and to record the delivery historical information on the stored delivery historical file; and an accounting device 300 having an accounting server 330 for performing an accounting process on the basis of the delivery historical information stored by the accounting servers 450 and 550 of the non-subscriber station devices 400 and 500.

### TECHNICAL FIELD OF INVENTION

This invention is related to a cable television system for providing a cable television service for a wireless terminal device moving within a service area among a plurality of cable television stations, a contents delivering device, an accounting device, a wireless terminal device, and a method of providing a cable television service by wireless.

### BACKGROUND ART

This kind of cable television service, referred to as “CATV service” hereinlater, has been coming into wide use before now. The CATV service includes television broadcasting provided for a fringe and local area, and a service for a connection with a computer communication network, such as an internet, and so on.

The broadcasting programs of this CATV service include contents concerning a weather forecast, traffic information, a program of an event, music, a movie, and so on. The user contracts with the cable television station, referred to as “CATV station” hereinafter, to be provided with these contents from the wireless terminal device mounted on a vehicle and to pay a fee accounted in exchange for the received contents.

The above conventional CATV service, however, has encountered a problem in that the CATV service cannot be provided when the vehicle moves into the service area of the other CATV station without the contract, referred to as “non-subscriber station” hereinafter, although the CATV service can be provided when the vehicle is located into the service area of the CATV station with which the contract has been made, referred to as “subscriber station” hereinafter.

It is therefore an object of the present invention to provide a cable television system, a contents delivering device, an accounting device, a wireless terminal device, and a method of providing a cable television service by wireless, which can provide a cable television service for a wireless terminal device from the non-subscriber station.

### DISCLOSURE OF THE INVENTION

It is a first object of the present invention to provide a cable television system comprising:

a plurality of contents delivering devices each having delivering means for delivering contents concerning a cable television service;

a wireless terminal device having wireless connection means for connecting to either one of said plural contents delivering devices by wireless; and

an accounting device having accounting means for performing an accounting process, wherein

each of said contents delivering devices further including:

delivery history storing means for acquiring a delivery historical file having a set of delivery historical information representative of a history of delivering said contents from the other contents delivering devices which have been just before connected to said wireless terminal device by said wireless connection means to store the acquired delivery historical file therein when said contents delivering device is connected to said wireless terminal device by said wireless connection means; and

delivery history recording means for recording said delivery historical information on said delivery historical file stored by said delivery history storing means when said contents are delivered to said wireless terminal device, which is connected by said wireless connection means, by said delivering means,

said accounting device being operated to have said accounting means perform said accounting process on the basis of said delivery historical information in said delivery historical file stored by said delivery history storing means.

In accordance with the above construction, the cable television system according to the present invention can have the non-subscriber station provide the cable television service for the wireless terminal device, because of the fact that the accounting device installed in the subscriber station can charge a user of the wireless terminal device a fee, even when the contents delivering device installed in the non-subscriber station is operated to provide the cable television service for the wireless terminal device.

The cable television system according to the present invention is adapted to have the contents delivering devices record the delivery historical information onto the delivery historical files stored in the contents delivering devices by themselves, whenever the contents are delivered to the wireless terminal device by the contents delivering devices, respectively. The cable television system according to the present invention is further adapted to have the accounting device perform the accounting process on the basis of delivery historical information recorded, by the contents delivering devices themselves, onto the delivery historical files stored in the contents delivering devices, respectively. This results in the fact that it is unnecessary for the accounting device to acquire the delivery historical information from the contents delivering devices whenever the contents delivering devices deliver the contents to the wireless terminal device.

The cable television system according to the present invention can therefore reduce the number of times of the communication between the accounting device installed in the subscriber station and the contents delivering devices installed in the non-subscriber stations when the contents delivering devices installed in the non-subscriber stations are operated to provide the cable television service for the wireless terminal device in comparison with that in the case where the cable television system is operated to have the accounting device acquire the delivery historical information from the contents delivering devices whenever the contents delivering devices deliver the contents to the wireless terminal device.

The cable television system according to the present invention is adapted to have one contents delivering device connected to the wireless terminal device acquire the delivery historical file from another contents delivering device which has been connected to the wireless terminal device just before the one contents delivering device is connected to the wireless terminal device, and to then store the acquired delivery historical file therein. The cable television system according to the present invention is further adapted to have the accounting device perform the accounting process on the basis of the delivery historical information in the delivery historical file stored by any of the plural contents delivering devices. This results in the fact that it is unnecessary for the accounting device to acquire the delivery historical information in the delivery historical file from all of the plural contents delivering devices.

The cable television system according to the present invention can therefore reduce the number of times of communication between the accounting device installed in the subscriber station and the contents delivering devices installed in the non-subscriber stations when the contents delivering devices installed in the non-subscriber stations are operated to provide the cable television service for the wireless terminal device in comparison with that in the case where the cable television system is operated to have the accounting device acquire the delivery historical information from all of the plural contents delivering devices.

In the cable television system according to the present invention, said wireless terminal device may include:

delivery receipt history storing means for storing a delivery receipt historical file having a set of delivery receipt historical information representative of a history of receiving said delivered contents; and

delivery receipt history recording means for recording said delivery receipt historical information on said delivery receipt historical file stored by said delivery receipt history storing means when said contents are delivered by said delivering means of said contents delivering device which is connected to said wireless terminal device by said wireless connection means,

said accounting device including matching means for matching between said histories concerning the delivered contents on the basis of said delivery historical information used by said accounting means and said delivery receipt historical information of said delivery receipt historical file stored by said delivery receipt history storing means.

In accordance with the above construction, the cable television system according to the present invention can be operated to have the accounting device detect an error of the histories concerning the delivered contents, thereby improving reliability of the accounting in comparison with that in the case where an error of the histories is not detected.

In the cable television system according to the present invention, said accounting device may have:

connection information acquiring means for acquiring connected device information representative of which of said contents delivering devices is connected to said wireless terminal device by said wireless connection means; and

last connected device judging means for judging which of said contents delivering devices was connected last to said wireless terminal device by said wireless connection means on the basis of said connected device information acquired by said connection information acquiring means, wherein

said accounting device is operated to have said accounting means perform said accounting process on the basis of said delivery historical information of said delivery historical file stored by said delivery history storing means of said contents delivering device which is judged by said last connected device judging means.

In accordance with the above construction, the cable television system according to the present invention can be operated to have the accounting device perform the accounting process on the basis of the latest delivery historical information.

It is a second object of the present invention to provide a cable television system comprising:

a plurality of contents delivering devices each having delivering means for delivering contents concerning a cable television service;

a wireless terminal device having wireless connection means for connecting to either one of said plural contents delivering devices by wireless; and

an accounting device having accounting means for performing an accounting process, wherein

each of said contents delivering devices further including:

delivery history storing means for storing therein a delivery historical file having a set of delivery historical information representative of a history of delivering said contents; and

delivery history recording means for recording said delivery historical information on said delivery historical file stored by said delivery history storing means when said contents are delivered by said delivering means to said wireless terminal device which is connected by said wireless connection means,

said accounting device having history accumulating means for accumulating said delivery historical information of said plural delivery historical file stored by said delivery history storing means of said plural contents delivering devices, and being operated to have said accounting means perform said accounting process on the basis of said delivery historical information accumulated by said history accumulating means.

In accordance with the above construction, the cable television system according to the present invention can have the non-subscriber station provide the cable television service for the wireless terminal device, because of the fact that the accounting device installed in the subscriber station can charge a user of the wireless terminal device a fee, even when the contents delivering device installed in the non-subscriber station is operated to provide the cable television service for the wireless terminal device.

The cable television system according to the present invention is adapted to have the contents delivering devices record the delivery historical information onto the delivery historical files stored in the contents delivering devices by themselves, whenever the contents are delivered to the wireless terminal device by the contents delivering devices, respectively. The cable television system according to the present invention is further adapted to have the accounting device perform the accounting process on the basis of delivery historical information recorded, by the contents delivering devices themselves, onto the delivery historical files stored in the contents delivering devices, respectively. This results in the fact that it is unnecessary for the accounting device to acquire the delivery historical information from the contents delivering devices whenever the contents delivering devices deliver the contents to the wireless terminal device.

The cable television system according to the present invention can therefore reduce the number of times of the communication between the accounting device installed in the subscriber station and the contents delivering devices installed in the non-subscriber stations when the contents delivering devices installed in the non-subscriber stations are operated to provide the cable television service for the wireless terminal device in comparison with that in the case where the cable television system is operated to have the accounting device acquire the delivery historical information from the contents delivering devices whenever the contents delivering devices deliver the contents to the wireless terminal device.

The cable television system according to the present invention is adapted to have a plurality of contents delivering devices store the delivery historical files, respectively, and to have the accounting device perform the accounting process on the basis of the delivery historical information in the plural delivery historical flies stored by the plural contents delivering devices, thereby making it unnecessary for the contents delivering devices to acquire the delivery historical file from another contents delivering device which has been just before connected to the wireless terminal device, when the contents delivering device are connected to the wireless terminal device.

The cable television system according to the present invention can therefore reduce the number of the communications among the contents delivering devices installed in a plurality of non-sub-scriber stations each other, in comparison with that in the case where the cable television system is operated to have the contents delivering devices acquire the delivery historical file from another contents delivering device which has been just before connected to the wireless terminal device, when the contents delivering devices are connected to the wireless terminal device.

In the cable television system according to the present invention, said wireless terminal device may include:

delivery receipt history storing means for storing a delivery receipt historical file having a set of delivery receipt historical information representative of a history of receiving said delivered contents; and

delivery receipt history recording means for recording said delivery receipt historical information on said delivery receipt historical file stored by said delivery receipt history storing means when said contents are delivered by said delivering means of said contents delivering device which is connected to said wireless terminal device by said wireless connection means,

said accounting device including matching means for matching between said histories concerning the delivered contents on the basis of said delivery historical information accumulated by said history accumulating means and said delivery receipt historical information of said delivery receipt historical file stored by said delivery receipt history storing means.

In accordance with the above construction, the cable television system according to the present invention can be operated to have the accounting device detect an error of the histories concerning the delivered contents, thereby improving reliability of the accounting in comparison with that in the case where an error of the histories is not detected.

In the cable television system according to the present invention, said accounting device may have error information transmitting means for transmitting said history error information indicative that there is an error in said histories concerning said contents delivery to said wireless terminal device when the judgment is made, by said matching means, that said histories concerning said contents delivery are unmatched with each other.

In accordance with the above construction, the cable television system according to the present invention can improve reliability of the accounting in comparison with that in the case where the notice that there is an error in the histories concerning the delivered contents is not given to the user of the wireless terminal device, because of the fact that the cable television system can be operated to have the accounting device notice the user of the wireless terminal device that there is an error in the histories concerning the delivered contents when the accounting device is operated to detect an error of the histories concerning the delivered contents.

In the cable television system according to the present invention, said accounting device may have connection information acquiring means for acquiring connected device information representative of which of said contents delivering devices is connected to said wireless terminal device by said wireless connection means, and

said contents delivering device having:

alteration protecting means for protecting, against an alteration, said delivery historical information of said delivery historical file stored by said delivery history storing means;

last connected device judging means for judging which another one of said contents delivering devices was connected last to said wireless terminal device by said wireless connection means on the basis of said connected device information acquired by said connection information acquiring means; and

instruction information transmitting means for transmitting start instruction information, which instructs the start of operation, to said alteration protecting means of said another contents delivering device judged by said last connected device judging means, and

said contents delivering device being operated to have said alteration protecting means protect, against the alteration, said delivery historical information of said delivery historical file stored by said delivery history storing means when said start instruction information is transmitted by said instruction information transmitting means of the other contents delivering device.

In accordance with the above construction, the cable television system is operated to have the contents delivering devices, only which are operated to deliver the contents to the wireless terminal device, alter the delivery historical information, thereby making it possible to improve reliability of the accounting in comparison with that in the case where the cable television system is operated to have any contents delivering devices besides some contents delivering devices, which are not operated to deliver the contents to the wireless terminal device, alter the delivery historical information.

In the cable television system according to the present invention, said contents delivering device may include alteration protecting means for protecting, against an alteration, said delivery historical information of said delivery historical file stored by said delivery history storing means when the connection with said wireless terminal device is halted by said wireless connection means.

In accordance with the above construction, the cable television system is operated to have the contents delivering devices, only which are operated to deliver the contents to the wireless terminal device, alter the delivery historical information, thereby making it possible to improve reliability of the accounting in comparison with that in the case where the cable television system is operated to have any contents delivering devices besides some contents delivering devices, which are not operated to deliver the contents to the wireless terminal device, alter the delivery historical information.

In the cable television system according to the present invention, said contents delivering device may be operated to have said delivery history recording means record said delivery historical information in accordance with a contents delivery situation indicative how said contents are delivered from said delivering means to said wireless terminal device connected by said wireless connection means.

In accordance with the above construction, the cable television system can be operated to have the contents delivering devices change the recording method of recording the delivery historical information in accordance with the contents delivery situation.

In the cable television system according to the present invention, said wireless terminal device has instruction information inputting means for inputting a recording method instructing information for instructing a recording method of recording said delivery historical information to said contents delivering device, and said contents delivering device being operated to have said delivery history recording means record said delivery historical information in accordance with said recording method instructing information inputted by said instruction information inputting means.

In accordance with the above construction, the cable television system can be operated to allow the user of the wireless terminal device to specify the recording method of recording the delivery historical information for the contents delivering devices, and then to have the contents delivering devices record the delivery historical information thereon by the recording method which is specified by the user of the wireless terminal device.

It is a third object of the present invention to provide a cable television system comprising:

a contents delivering device having delivering means for delivering contents concerning a cable television service;

a wireless terminal device having wireless connection means for connecting to said contents delivering device by wireless; and

an authentication information registration device having registered information storing means for storing therein a registered authentication information previously registered for an authentication process, wherein

said wireless terminal device has authentication information transmitting means for transmitting, to said contents delivering device which is connected by said wireless connection means, input authentication information inputted for said authentication process,

said contents delivering device having:

acquired information storing means for acquiring said registered authentication information stored by said registered information storing means to store the acquired registered authentication information therein;

acquired information authentication means for perform said authentication process of authenticating a user of said wireless terminal device on the basis of said input authentication information transmitted by said authentication information transmitting means and said registered authentication information stored by said acquired information storing means; and

delivery permitting means for permitting said delivering means to deliver said contents to said wireless terminal device connected by said wireless connection means when said user of said wireless terminal device is authenticated by said acquired information authentication means.

In accordance with the above construction, the cable television system can have the contents delivering devices installed in the non-subscriber stations perform the authentication process of authenticating the user of the wireless terminal device, thereby making it possible to have the non-subscriber stations provide the cable television service for the wireless terminal device.

In the cable television system according to the present invention, the cable television system can further be operated to have the contents delivering devices store the registered authentication information acquired from the authentication information registration device and then perform by themselves the authentication process of authenticating the user of the wireless terminal device on the basis of the registered authentication information stored in the contents delivering devices, thereby reducing the number of times of the communication between the subscriber station and the non-subscriber station in comparison with that in case where the contents delivering devices installed in the non-subscriber stations are operated to query the authentication information registration device installed in the subscriber station whenever the user of the wireless terminal device requests to log into the contents delivering devices installed in the non-subscriber stations.

In the cable television system according to the present invention, said contents delivering device may have authentication information transferring means for transferring said input authentication information transmitted by said authentication information transmitting means to said authentication information registration device, said authentication information registration device having transfer information authentication means for performing said authentication process of authenticating the user of said wireless terminal device on the basis of said input authentication information transmitted by said authentication information transferring means and said registered authentication information stored by said registered information storing means, and

said contents delivering device being operated to have said acquired information storing means acquire and store therein said registered authentication information stored by said registered information storing means and store therein the acquired registered authentication information when said user of said wireless terminal device is authenticated by said transfer information authentication means.

In accordance with the above construction, the cable television system according to the present invention can have the contents delivering devices installed in the non-subscriber stations query the authentication information registration devices installed in a plurality of subscriber stations.

In the cable television system according to the present invention, said authentication information transferring means may be operated to transfer said input authentication information to said authentication information registration device on the basis of said input authentication information transmitted by said authentication information transmitting means.

In accordance with the above construction, the cable television system can be operated to have the contents delivering devices judge which of the subscriber stations is subscribed by the user of the wireless terminal device, on the basis of the input authentication information, and to then transfer the input authentication information to the authentication information registration device installed in the subscriber station which is subscribed by the user of the wireless terminal device, thereby reducing the number of times of the communication between the CATV stations in comparison with that in case where the cable television system is operated to have the contents delivering devices transfer the input authentication information to a plurality of CATV stations.

In the cable television system according to the present invention, said authentication information registration device may be operated to transmit the result of said authentication process to said contents delivering device only when the user of said wireless terminal device is authenticated by said transfer information authentication means.

In accordance with the above construction, for example, when the cable television system is operated to have the contents delivering devices installed in the non-subscriber stations query the authentication information registration devices installed in a plurality of CATV stations, the cable television system is operated to select the authentication information registration device installed in the subscriber station which is subscribed by the user of the wireless terminal device from among a plurality of CATV stations to have only the selected authentication information registration device transmit the result of the authentication process to the contents delivering devices. This results in the fact that the number of times of communication between the CATV stations is reduced in comparison with that in case where the cable television system is operated to have whole of the authentication information registration devices installed in a plurality of CATV stations transmit the result of the authentication process to the contents delivering devices installed in the non-subscriber stations.

In the cable television system according to the present invention, said contents delivering device may be operated to have said acquired information storing means record said registered authentication information for a predetermined duration.

In accordance with the above construction, the cable television system can remain a security for the authentication process.

In the cable television system according to the present invention, at least a part of said input authentication information may be recorded on a record medium, and said wireless terminal device being operated to receive said input authentication information recorded on said record medium.

In accordance with the above construction, the cable television system can remain a security for the authentication process.

It is a fourth object of the present invention to provide a contents delivering device comprising:

delivering means for delivering a contents concerning a cable television service;

delivery history storing means for acquiring a delivery historical file having a set of delivery historical information representative of a history of delivering said contents from another contents delivering device which has been just before connected to a wireless terminal device by wireless and to then store the acquired delivery historical file therein when said contents delivering device is connected to said wireless terminal device by wireless; and

delivery history recording means for recording said delivery historical information on said delivery historical file stored by said delivery history storing means when said contents are delivered, by said delivering means, to said wireless terminal device which is connected by wireless.

In accordance with the above construction, the contents delivering device according to the present invention can provide the wireless terminal device with the cable television service delivered from the non-subscriber stations, because of the fact that the contents delivering device can have the accounting device installed in the subscriber station charge a user of the wireless terminal device a fee, even when the contents delivering device is installed in the non-subscriber station and operated to provide the cable television service for the wireless terminal device.

The contents delivering device according to the present invention is adapted to record the delivery historical information onto the delivery historical file stored in the contents delivering device by itself, whenever the contents are delivered to the wireless terminal device by the contents delivering device. The contents delivering device is further adapted to have the accounting device perform the accounting process on the basis of delivery historical information recorded, by the contents delivering device itself, onto the delivery historical file stored in the contents delivering device. This results in the fact that it is unnecessary for the accounting device to acquire the delivery historical information from the contents delivering device whenever the contents delivering device delivers the contents to the wireless terminal device.

The contents delivering device according to the present invention can therefore reduce the number of times of the communication with the accounting device installed in the subscriber station when the contents delivering device installed in the non-subscriber station is operated to provide the cable television service for the wireless terminal device in comparison with that in the case where the contents delivering device is operated to have the accounting device acquire the delivery historical information whenever the contents delivering device delivers the contents to the wireless terminal device.

The contents delivering device according to the present invention is adapted to acquire the delivery historical file from another contents delivering device which has been connected to the wireless terminal device just before the one contents delivering device is connected to the wireless terminal device, and to then store the acquired delivery historical file therein when the contents delivering device is connected to the wireless terminal device. The contents delivering device according to the present invention is further adapted to have the accounting device perform the accounting process on the basis of the delivery historical information in the delivery historical file stored by any of the plural contents delivering devices. This results in the fact that it is unnecessary for the accounting device to acquire the delivery historical information in the delivery historical file from all of the plural contents delivering devices.

The contents delivering device can therefore reduce the number of times of communication with the accounting device installed in the subscriber station when the contents delivering device installed in the non-subscriber station is operated to provide the cable television service for the wireless terminal device in comparison with that in the case where the contents delivering device is operated to have the accounting device acquire the delivery historical information from all of the plural contents delivering devices.

It is a fifth object of the present invention to provide a contents delivering device comprising:

delivering means for delivering a contents concerning a cable television service;

delivery history storing means for acquiring a delivery historical file having a set of delivery historical information representative of a history of delivering said contents to a wireless terminal device connected by wireless by said delivering means; and

delivery history recording means for recording said delivery historical information on said delivery historical file stored by said delivery history storing means when said contents are delivered, by said delivering means, to said wireless terminal device which is connected by wireless.

In accordance with the above construction, the contents delivering device according to the present invention can provide the wireless terminal device with the cable television service delivered from the non-subscriber stations, because of the fact that the contents delivering device can have the accounting device installed in the subscriber station charge a user of the wireless terminal device a fee, even when the contents delivering device is installed in the non-subscriber station and operated to provide the cable television service for the wireless terminal device.

The contents delivering device according to the present invention is adapted to record the delivery historical information onto the delivery historical file stored in the contents delivering device by itself, whenever the contents are delivered to the wireless terminal device by the contents delivering device. The contents delivering device is further adapted to have the accounting device perform the accounting process on the basis of delivery historical information recorded, by the contents delivering device itself, onto the delivery historical file stored in the contents delivering device. This results in the fact that it is unnecessary for the accounting device to acquire the delivery historical information from the contents delivering device whenever the contents delivering device delivers the contents to the wireless terminal device.

The contents delivering device according to the present invention can therefore reduce the number of times of the communication with the accounting device installed in the subscriber station when the contents delivering device installed in the non-subscriber station is operated to provide the cable television service for the wireless terminal device in comparison with that in the case where the contents delivering device is operated to have the accounting device acquire the delivery historical information whenever the contents delivering device delivers the contents to the wireless terminal device.

The contents delivering device according to the present invention is adapted to store the delivery historical file therein and further to have the accounting device perform the accounting process on the basis of the delivery historical information in a plurality of delivery historical files stored by a plurality of contents delivering devices. This results in the fact that it is unnecessary for the accounting device to acquire the delivery historical file from another contents delivering device which has been connected to the wireless terminal device just before the contents delivering device is connected to the wireless terminal device.

The contents delivering device can therefore reduce the number of times of communication with the other contents delivering devices installed in the other non-subscriber stations when the contents delivering device installed in the non-subscriber station is operated to provide the cable television service for the wireless terminal device in comparison with that in the case where the contents delivering device is operated to acquire the delivery historical file from the other plural contents delivering devices installed in the other non-subscriber stations.

Furthermore, the contents delivering device according to the present invention may comprise:

alteration protecting means for protecting, against an alteration, said delivery historical information of said delivery historical file stored by said delivery history storing means;

last connected device judging means for judging which another one of said contents delivering devices was connected last to said wireless terminal device by wireless when said contents delivering device is connected to said wireless terminal device by wireless; and

instruction information transmitting means for transmitting start instruction information to said another contents delivering device judged by said last connected device judging means, and

said contents delivering device being operated to have said alteration protecting means protect, against the alteration, said delivery historical information of said delivery historical file stored by said delivery history storing means when said start instruction information is transmitted to said alteration protecting means by the other contents delivering devices.

In accordance with the above construction, the contents delivering device according to the present invention can alter the delivery historical information only when the contents delivering device is operated to deliver the contents to the wireless terminal device, thereby making it possible to improve reliability of the accounting in comparison with that in the case where the contents delivering device is operated to alter the delivery historical information when the contents delivering device is not operated to deliver the contents to the wireless terminal device.

The contents delivering device according to the present invention may further comprise alteration protecting means for protecting, against an alteration, said delivery historical information of said delivery historical file stored by said delivery history storing means when the wireless connection with said wireless terminal device is halted.

In accordance with the above construction, the contents delivering device according to the present invention can be operated to alter the delivery historical information only when the contents delivering device is operated to deliver the contents to the wireless terminal device, thereby making it possible to improve reliability of the accounting in comparison with that in the case where the contents delivering device is operated to alter the delivery historical information when the contents delivering device is not operated to deliver the contents to the wireless terminal device.

The contents delivering device according to the present invention may be operated to have said delivery history recording means record said delivery historical information in accordance with a contents delivery situation indicative how said contents are delivered from said delivering means to said wireless terminal device connected by wireless.

In accordance with the above construction, the contents delivering device according to the present invention can change the recording method of recording the delivery historical information in accordance with the contents delivery situation.

Furthermore, the contents delivering device according to the present invention may be operated to have said delivery history recording means record said delivery historical information in accordance with said recording method instructing information which is inputted by instruction information inputting means so as to instruct a recording method of recording said delivery historical information and transmitted from said wireless terminal device.

In accordance with the above construction, the contents delivering device according to the present invention can be operated to allow the user of the wireless terminal device to specify the recording method of recording the delivery historical information, and then to record the delivery historical information thereon by the recording method which is specified by the user of the wireless terminal device.

It is a sixth object of the present invention to provide a contents delivering device comprises:

delivering means for delivering contents concerning a cable television service to a wireless terminal device connected by wireless;

acquired information storing means for acquiring, from an authentication information registration device, a registered authentication information which is previously registered and stored in said authentication information registration device for an authentication process and to then store the acquired registered authentication information therein;

acquired information authentication means for perform said authentication process of authenticating a user of said wireless terminal device on the basis of: input authentication information transmitted from said wireless terminal device which is inputted to said wireless terminal device for said authentication process; and said registered authentication information stored by said acquired information storing means; and

delivery permitting means for permitting said delivering means to deliver said contents to said wireless terminal device connected by wireless when said user of said wireless terminal device is authenticated by said acquired information authentication means.

In accordance with the above construction, the contents delivering device according to the present invention can provide the wireless terminal device with the cable television service delivered from the non-subscriber stations, because of the fact that the contents delivering device can authenticate the user of the wireless terminal device even when the contents delivering device is installed in the non-subscriber station.

Moreover, the contents delivering devices is adapted to store the registered authentication information acquired from the authentication information registration device and then perform the authentication process of authenticating the user of the wireless terminal device on the basis of the registered authentication information stored in the contents delivering device itself, thereby reducing the number of times of the communication with the subscriber station in comparison with that in case where the contents delivering device is installed in the non-subscriber station and operated to query the authentication information registration device installed in the subscriber station whenever the user of the wireless terminal device requests to log into the contents delivering device installed in the non-subscriber station.

Furthermore, the contents delivering device according to the present invention comprises authentication information transferring means for transferring, to said authentication information registration device, said input authentication information transmitted from said wireless terminal device,

said authentication information registration device being operated to perform said authentication process of authenticating the user of said wireless terminal device on the basis of said input authentication information transmitted by said authentication information transferring means and said stored registered authentication information, and

said contents delivering device being operated to have said acquired information storing means acquire said registered authentication information stored by said authentication information registration device and to then store therein the acquired registered authentication information when said user of said wireless terminal device is authenticated.

In accordance with the above construction, the contents delivering device according to the present invention can be operated to query the authentication information registration devices installed in a plurality of CATV stations when the contents delivering device is installed in the non-subscriber station.

Moreover, the contents delivering device according to the present invention may be operated to have said acquired information storing means record said registered authentication information for a predetermined duration.

In accordance with the above construction, the contents delivering device according to the present invention can remain a security for the authentication process.

It is a seventh object of the present invention to provide a n accounting device comprising accounting means for performing an accounting process on the basis of a set of delivery historical information representative of a history of delivering contents from a contents delivering device to a wireless terminal device which is connected to said contents delivering device by wireless, and said delivery historical information being stored in a delivery historical file by a plurality of said contents delivering devices.

In accordance with the above construction, the accounting device according to the present invention can be operated to provide the wireless terminal device with the cable television service delivered from the non-subscriber station because of the fact that the accounting device can charge a user of the wireless terminal device a fee, even when the accounting device is installed in the subscriber station and the contents delivering device installed in the non-subscriber station is operated to provide the cable television service for the wireless terminal device.

The accounting device according to the present invention is adapted to have the contents delivering devices record the delivery historical information onto the delivery historical files stored in the contents delivering devices by themselves, whenever the contents are delivered to the wireless terminal device by the contents delivering devices, respectively. The accounting device according to the present invention is further adapted to perform the accounting process on the basis of delivery historical information recorded, by the contents delivering devices themselves, onto the delivery historical files stored in the contents delivering devices, respectively. This results in the fact that it is unnecessary for the accounting device according to the present invention to acquire the delivery historical information from the contents delivering devices whenever the contents delivering devices deliver the contents to the wireless terminal device.

The accounting device according to the present invention can therefore reduce the number of times of the communication with the contents delivering devices installed in the non-subscriber stations when the contents delivering devices installed in the non-subscriber stations are operated to provide the cable television service for the wireless terminal device in comparison with that in the case where the accounting device is operated to acquire the delivery historical information from the contents delivering devices whenever the contents delivering devices deliver the contents to the wireless terminal device.

The accounting device according to the present invention is adapted to have one contents delivering device connected to the wireless terminal device acquire the delivery historical file from another contents delivering device which has been connected to the wireless terminal device just before the one contents delivering device is connected to the wireless terminal device, and to then store the acquired delivery historical file therein. The accounting device according to the present invention is further adapted to perform the accounting process on the basis of the delivery historical information in the delivery historical file stored by any of the plural contents delivering devices. This results in the fact that it is unnecessary for the accounting device according to the present invention to acquire the delivery historical information in the delivery historical file from all of the plural contents delivering devices when the accounting process is performed.

The accounting device according to the present invention can therefore reduce the number of times of communication with the contents delivering devices installed in the non-subscriber stations when the contents delivering devices installed in the non-subscriber stations are operated to provide the cable television service for the wireless terminal device in comparison with that in the case where the accounting device is operated to acquire the delivery historical information from all of the plural contents delivering devices.

Furthermore, the accounting device according to the present invention comprises matching means for matching between histories concerning the delivered contents on the basis of: said delivery historical information used by said accounting means; and delivery receipt historical information representative of a history of receiving said delivered contents, and a set of said delivery receipt historical information being stored in a delivery receipt historical file by said wireless terminal device.

In accordance with the above construction, the accounting device according to the present invention can detect an error of the histories concerning the delivered contents, thereby improving reliability of the accounting in comparison with that in the case where an error of the histories is not detected.

Furthermore, the accounting device according to the present invention comprises:

connection information acquiring means for acquiring connected device information representative of which of said contents delivering devices is connected to said wireless terminal device by wireless; and

last connected device judging means for judging which of said contents delivering devices was connected last to said wireless terminal device by wireless on the basis of said connected device information acquired by said connection information acquiring means,

said accounting device having said accounting means perform said accounting process on the basis of said delivery historical information of said delivery historical file stored by said delivery history storing means of said contents delivering device which is judged by said last connected device judging means.

In accordance with the above construction, the accounting device according to the present invention can perform the accounting process on the basis of the latest delivery historical information.

It is an eighth object of the present invention to provide an accounting device comprising:

history accumulating means for accumulating a set of delivery historical information representative of a history of delivering contents from a contents delivering device to a wireless terminal device which is connected to said contents delivering device by wireless, and a set of said delivery historical information being stored in a plurality of delivery historical files by a plurality of said contents delivering devices, respectively; and

accounting means for performing an accounting process on the basis of said delivery historical information accumulated by said history accumulating means.

In accordance with the above construction, the accounting device according to the present invention can be operated to provide the wireless terminal device with the cable television service delivered from the non-subscriber station because of the fact that the accounting device is installed in the subscriber station and can charge a user of the wireless terminal device a fee, even when the contents delivering device installed in the non-subscriber station is operated to provide the cable television service for the wireless terminal device.

The accounting device according to the present invention is adapted to have the contents delivering devices record the delivery historical information onto the delivery historical files stored in the contents delivering devices by themselves, whenever the contents are delivered to the wireless terminal device by the contents delivering devices, respectively. The accounting device according to the present invention is further adapted to perform the accounting process on the basis of delivery historical information recorded, by the contents delivering devices themselves, onto the delivery historical files stored in the contents delivering devices, respectively. This results in the fact that it is unnecessary for the accounting device according to the present invention to acquire the delivery historical information from the contents delivering devices whenever the contents delivering devices deliver the contents to the wireless terminal device.

The accounting device according to the present invention can therefore reduce the number of times of the communication with the contents delivering devices installed in the non-subscriber stations when the contents delivering devices installed in the non-subscriber stations are operated to provide the cable television service for the wireless terminal device in comparison with that in the case where the accounting device is operated to acquire the delivery historical information from the contents delivering devices whenever the contents delivering devices deliver the contents to the wireless terminal device.

The accounting device according to the present invention is adapted to have a plurality of contents delivering devices store the delivery historical files, respectively, and to perform the accounting process on the basis of the delivery historical information in the plural delivery historical files stored by the plural contents delivering devices. This results in the fact that it is unnecessary for one contents delivering device connected to the wireless terminal device to acquire the delivery historical file from the other contents delivering device connected just before to the wireless terminal device.

The accounting device according to the present invention can therefore reduce the number of times of the communications among the contents delivering devices installed in the plural non-subscriber stations each other, in comparison with that in the case where the accounting device is operated to have one contents delivering device which is connected to the wireless terminal device, acquire the delivery historical file from the other contents delivering device which have been just before connected to the wireless terminal device.

Moreover, the accounting device according to the present invention may comprise matching means for matching between histories concerning the delivered contents on the basis of: said delivery historical information accumulated by said history accumulating means; and delivery receipt historical information representative of a history of receiving said delivered contents, and a set of said delivery receipt historical information being stored in a delivery receipt historical file by said wireless terminal device which is connected to said contents delivering device by wireless.

In accordance with the above construction, the accounting device according to the present invention can be operated to detect an error in the histories concerning the delivered contents, thereby improving reliability in the accounting in comparison with that in the case where the error in the histories is not detected.

Furthermore, the accounting device according to the present invention may comprise error information transmitting means for transmitting a history error information indicative that said histories concerning said contents delivery have an error when the judgment is made, by said matching means, that said histories concerning said contents delivery are unmatched with each other.

In accordance with the above construction, the accounting device according to the present invention can be operated to notice the user of the wireless terminal device that the histories have an error when the accounting device detects the error in the histories concerning the delivered contents, thereby improving reliability in the accounting in comparison with that in the case where the accounting device is not operated to notice the user of the wireless terminal device that the histories have an error.

It is a ninth object of the present invention to provide a wireless terminal device comprising:

wireless connection means for connecting by wireless to said contents delivering device which is adapted to deliver contents concerning a cable television service; and

instruction information inputting means for inputting a recording method instructing information to instruct, to said contents delivering device, a recording method of recording delivery historical information representative of a history of delivering said contents to said contents delivering device.

In accordance with the above construction, the wireless terminal device according to the present invention can be operated to provide the wireless terminal device with the cable television service delivered from the non-subscriber station because of the fact that the wireless terminal device can be operated to have the accounting device installed in the subscriber station charge a user of the wireless terminal device a fee, even when the wireless terminal device is provided with the cable television service from the contents delivering device installed in the non-subscriber station. Moreover, the wireless terminal device according to the present invention can be operated to allow the user to specify the recording method of recording the delivery historical information for the contents delivering devices, and then to have the contents delivering devices record the delivery historical information thereon by the recording method which is specified by the user.

It is a tenth object of the present invention to provide a wireless terminal device comprising:

wireless connection means for connecting by wireless to said contents delivering device which is adapted to deliver contents concerning a cable television service;

delivery receipt history storing means for storing a delivery receipt historical file having a set of delivery receipt historical information representative of a history of receiving said contents delivered by said contents delivering device; and

delivery receipt history recording means for recording said delivery receipt historical information on said delivery receipt historical file stored by said delivery receipt history storing means when said contents are delivered by said contents delivering device which is connected to said wireless terminal device by said wireless connection means.

In accordance with the above construction, the wireless terminal device according to the present invention can be operated to provide the wireless terminal device with the cable television service delivered from the non-subscriber station because of the fact that the wireless terminal device can be operated to have the accounting device installed in the subscriber station charge a user of the wireless terminal device a fee, even when the wireless terminal device is provided with the cable television service from the contents delivering device installed in the non-subscriber station. Moreover, the wireless terminal device according to the present invention can be operated to have the accounting device detect an error of the histories concerning the delivered contents, thereby improving reliability of the accounting in comparison with that in the case where an error of the histories is not detected.

It is an eleventh third object of the present invention to provide a method of providing a cable television service by wireless, comprising:

a wireless connecting step of allowing a wireless terminal device to connect, by wireless, to any of a plurality of contents delivering devices which is adapted to deliver contents concerning a cable television service;

a delivering step of allowing said contents delivering device to deliver said contents to said wireless terminal device connected in said wireless connecting step;

a delivery history storing step of allowing said contents delivering device to acquire a delivery historical file having a set of delivery historical information representative of a history of delivering said contents from another contents delivering device which has been just before connected to said wireless terminal device in said wireless connecting step, to then store the acquired delivery historical file therein when said contents delivering device is connected to said wireless terminal device in said wireless connecting step;

a delivery history recording step of allowing said contents delivering device to record said delivery historical information on said delivery historical file stored in said delivery history storing step when said contents are delivered, in said delivering step, to said wireless terminal device which is connected in said wireless connecting step; and

an accounting step of allowing an accounting device to perform an accounting process on the basis of said delivery historical information of said delivery historical file stored in said delivery history storing step.

In accordance with the above construction, the method of providing a cable television service by wireless according to the present invention can have the non-subscriber station provide the cable television service for the wireless terminal device, because of the fact that the accounting device installed in the subscriber station can charge a user of the wireless terminal device a fee, even when the contents delivering device installed in the non-subscriber station is operated to provide the cable television service for the wireless terminal device.

In the method of providing a cable television service by wireless according to the present invention, the contents delivering devices is adapted to record the delivery historical information onto the delivery historical files stored in the contents delivering devices by themselves, whenever the contents are delivered to the wireless terminal device by the contents delivering devices, respectively. In the method of providing a cable television service by wireless according to the present invention, the accounting device is adapted to perform the accounting process on the basis of delivery historical information recorded, by the contents delivering devices themselves, onto the delivery historical files stored in the contents delivering devices, respectively. This results in the fact that it is unnecessary for the accounting device to acquire the delivery historical information from the contents delivering devices whenever the contents delivering devices deliver the contents to the wireless terminal device.

The method of providing a cable television service by wireless according to the present invention can therefore reduce the number of times of the communication between the accounting device installed in the subscriber station and the contents delivering devices installed in the non-subscriber stations when the contents delivering devices installed in the non-subscriber stations are operated to provide the cable television service for the wireless terminal device in comparison with that in the case where the accounting device is operated to acquire the delivery historical information from the contents delivering devices whenever the contents delivering devices deliver the contents to the wireless terminal device.

In the method of providing a cable television service by wireless according to the present invention, one contents delivering device connected to the wireless terminal device is adapted to acquire the delivery historical file from another contents delivering device which has been connected to the wireless terminal device just before the one contents delivering device is connected to the wireless terminal device, and to then store the acquired delivery historical file therein. In the method of providing a cable television service by wireless according to the present invention, the accounting device is adapted to perform the accounting process on the basis of the delivery historical information in the delivery historical file stored by any of the plural contents delivering devices. This results in the fact that it is unnecessary for the accounting device to acquire the delivery historical information in the delivery historical file from all of the plural contents delivering devices.

The method of providing a cable television service by wireless according to the present invention can therefore reduce the number of times of communication between the accounting device installed in the subscriber station and the contents delivering devices installed in the non-subscriber stations when the contents delivering devices installed in the non-subscriber stations are operated to provide the cable television service for the wireless terminal device in comparison with that in the case where the accounting device is operated to acquire the delivery historical information from all of the plural contents delivering devices.

It is a twelfth object of the present invention to provide a method of providing a cable television service by wireless, comprising:

a wireless connecting step of allowing a wireless terminal device to connect, by wireless, to any of a plurality of contents delivering devices which is adapted to deliver contents concerning a cable television service;

a delivering step of allowing said contents delivering device to deliver said contents to said wireless terminal device connected in said wireless connecting step;

a delivery history storing step of allowing said contents delivering device to store therein a delivery historical file having a set of delivery historical information representative of a history of delivering said contents;

a delivery history recording step of allowing said contents delivering device to record said delivery historical information on said delivery historical file stored in said delivery history storing step when said contents are delivered in said delivering step to said wireless terminal device which is connected in said wireless connecting step;

history accumulating step of allowing an accounting device to accumulate said delivery historical information of a plurality of said delivery historical files stored by a plurality of said contents delivering devices, respectively, in said delivery history storing step; and

an accounting step of allowing said accounting device to perform an accounting process on the basis of said delivery historical information accumulated in said history accumulating step.

In accordance with the above construction, the method of providing a cable television service by wireless according to the present invention can have the non-subscriber station provide the cable television service for the wireless terminal device, because of the fact that the accounting device installed in the subscriber station can charge a user of the wireless terminal device a fee, even when the contents delivering device installed in the non-subscriber station is operated to provide the cable television service for the wireless terminal device.

In the method of providing a cable television service by wireless according to the present invention, the contents delivering devices is adapted to record the delivery historical information onto the delivery historical files stored in the contents delivering devices by themselves, whenever the contents are delivered to the wireless terminal device by the contents delivering devices, respectively. In the method of providing a cable television service by wireless according to the present invention, the accounting device is adapted to perform the accounting process on the basis of delivery historical information recorded, by the contents delivering devices themselves, onto the delivery historical files stored in the contents delivering devices, respectively. This results in the fact that it is unnecessary for the accounting device to acquire the delivery historical information from the contents delivering devices whenever the contents delivering devices deliver the contents to the wireless terminal device.

The method of providing a cable television service by wireless according to the present invention can therefore reduce the number of times of the communication between the accounting device installed in the subscriber station and the contents delivering devices installed in the non-subscriber stations when the contents delivering devices installed in the non-subscriber stations are operated to provide the cable television service for the wireless terminal device in comparison with that in the case where the accounting device is operated to acquire the delivery historical information from the contents delivering devices whenever the contents delivering devices deliver the contents to the wireless terminal device.

In method of providing a cable television service by wireless according to the present invention, a plurality of contents delivering devices is adapted to store the delivery historical files, respectively, and the accounting device is adapted to perform the accounting process on the basis of the delivery historical information in the plural delivery historical flies stored by the plural contents delivering devices, thereby making it unnecessary for the contents delivering devices to acquire the delivery historical file from another contents delivering device which has been just before connected to the wireless terminal device, when the contents delivering device are connected to the wireless terminal device.

The method of providing a cable television service by wireless according to the present invention can therefore reduce the number of the communications among the contents delivering devices installed in a plurality of non-sub-scriber stations each other, in comparison with that in the case where the contents delivering devices is operated to acquire the delivery historical file from another contents delivering device which has been just before connected to the wireless terminal device, when the contents delivering devices are connected to the wireless terminal device.

It is a thirteenth object of the present invention to provide a method of providing a cable television service by wireless, comprising:

a wireless connecting step of allowing a wireless terminal device to connect, by wireless, to any of a plurality of contents delivering devices which is adapted to deliver contents concerning a cable television service;

a delivering step of allowing said contents delivering device to deliver said contents to said wireless terminal device connected in said wireless connecting step;

a registered information storing step of allowing an authentication information registration device to store therein a registered authentication information previously registered for an authentication process;

an authentication information transmitting step of allowing said wireless terminal device to transmit, to said contents delivering device which is connected in said wireless connecting step, input authentication information inputted for said authentication process;

an acquired information storing step of allowing said contents delivering device to acquire said registered authentication information stored in said registered information storing step, to then store the acquired registered authentication information therein;

an acquired information authentication step of allowing said contents delivering device to perform said authentication process of authenticating a user of said wireless terminal device on the basis of said input authentication information transmitted in said authentication transmitting step and said registered authentication information stored in said acquired information storing step; and

a delivery permitting step of allowing said contents delivering device to permit delivering said contents to said wireless terminal device connected in said wireless connecting step when said user of said wireless terminal device is authenticated in said acquired information authentication step.

In accordance with the above construction, the method of providing a cable television service by wireless can have the contents delivering devices installed in the non-subscriber stations perform the authentication process of authenticating the user of the wireless terminal device, thereby making it possible to have the non-subscriber stations provide the cable television service for the wireless terminal device.

In the method of providing a cable television service by wireless according to the present invention, the contents delivering devices can further be operated to store the registered authentication information acquired from the authentication information registration device and then perform by themselves the authentication process of authenticating the user of the wireless terminal device on the basis of the registered authentication information stored in the contents delivering devices, thereby reducing the number of times of the communication between the subscriber station and the non-subscriber station in comparison with that in case where the contents delivering devices installed in the non-subscriber stations are operated to query the authentication information registration device installed in the subscriber station whenever the user of the wireless terminal device requests to log into the contents delivering devices installed in the non-subscriber stations.

### BRIEF DESCRIPTION OF THE DRAWINGS

FIG. 1 is a block diagram showing a first preferred embodiment of the cable television system according to the present invention;

FIG. 2 is a schematic diagram showing the first preferred embodiment of a method of providing a cable television service by wireless;

FIG. 3 is a diagram showing a procedure of the method of providing the cable television service by wireless shown in FIG. 2;

FIG. 4 is a diagram showing a following procedure of the method of providing the cable television service by wireless shown in FIG. 3;

FIG. 5 is a diagram showing a following procedure of the method of providing the cable television service by wireless shown in FIG. 4;

FIG. 6 is a schematic diagram showing a second preferred embodiment of a method of providing a cable television service by wireless;

FIG. 7 is a diagram showing a procedure of the method of providing the cable television service by wireless shown in FIG. 6;

FIG. 8 is a diagram showing a following procedure of the method of providing the cable television service by wireless shown in FIG. 7;

FIG. 9 is a diagram showing a following procedure of the method of providing the cable television service by wireless shown in FIG.8;

FIG. 10 is a schematic diagram showing a third preferred embodiment of a method of providing a cable television service by wireless;

FIG. 11 is a diagram showing a procedure of the method of providing the cable television service by wireless shown in FIG. 10;

FIG. 12 is a diagram showing a following procedure of the method of providing the cable television service by wireless shown in FIG. 11;

FIG. 13 is a diagram showing a following procedure of the method of providing the cable television service by wireless shown in FIG. 12; and

FIG. 14 is a diagram showing another embodiment of the procedure of the method of providing the cable television service by wireless shown in FIG. 3.

### BEST MODE OF CARRYING OUT THE PRESENT INVENTION

The preferred embodiments of the present invention will be described hereinafter with reference to the drawings.

(A First Preferred Embodiment)

The construction of the first embodiment of a cable television system will be described first.

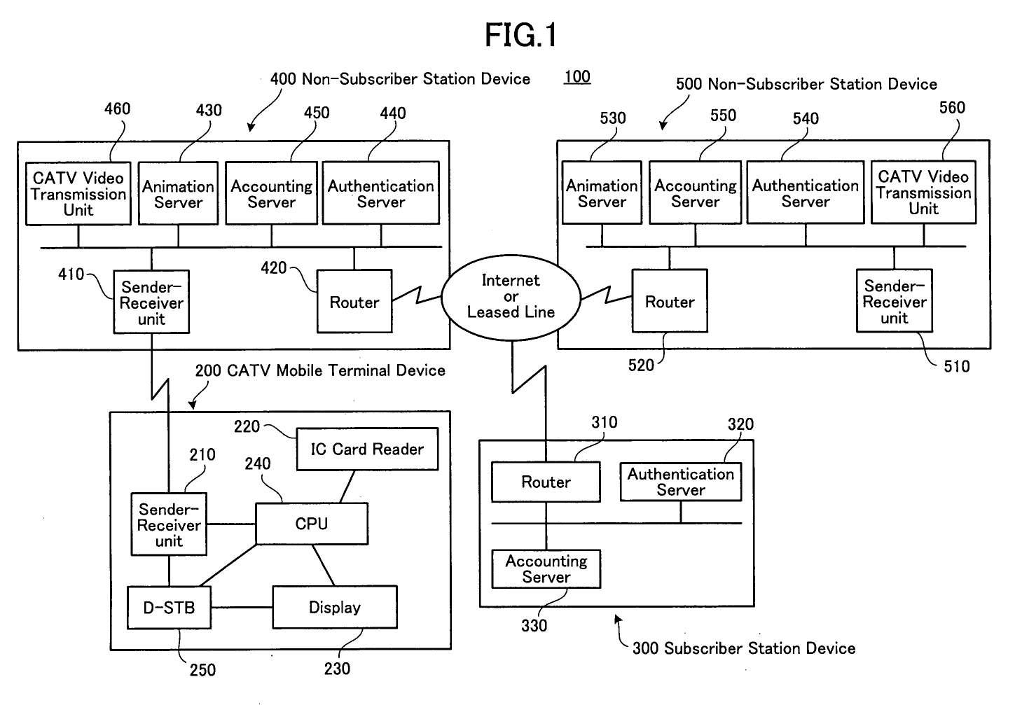

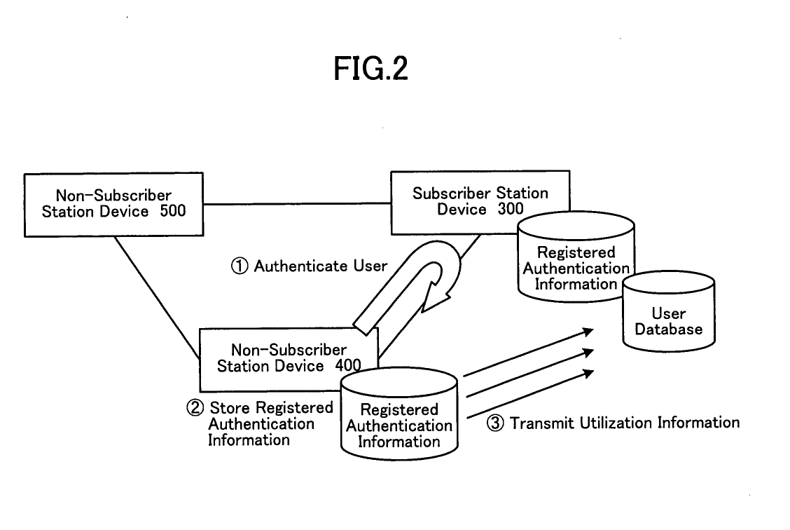

As shown in FIGS. 1 and 2, this embodiment of the cable television system 100 comprises: a CATV mobile terminal device 200 mounted on a vehicle, and serving as a wireless terminal device for connecting to a CATV station by wireless; a subscriber station device 300 installed in a subscriber station subscribed by a user of the CATV mobile terminal device 200, and serving as an authentication information registration device for delivering contents concerning a CATV service, and non-subscriber station devices 400 and 500 installed in the individual non-subscriber stations which have not subscribed by the user of the CATV mobile terminal device 200, and serving as a contents delivering device for delivering the contents concerning the CATV service.

The CATV mobile terminal device 200 comprises: a sender-receiver unit 210 serving as wireless connection means for connecting to either one of the subscriber station device 300 and the non-subscriber station devices 400 and 500 by wireless; an IC card reader 220 for reading information from a record medium such as an IC card; a display 230 for displaying the contents received through the sender-receiver unit 210; a CPU 240 included in a notebook-sized personal computer for controlling the sender-receiver unit 210, the IC card reader 220, and the display 230; and a digital signal video converting unit (D-STB) 250 for converting, into a video signal, a CATV digital video signal which has been compressed into an MPEG format and transmitted.

The CPU 240 of the notebook-sized personal computer includes: a data inputting function for allowing the user to input data such as a password; and a memorizing function for recording a diversity of information.

In this embodiment, the information recorded on the IC card, and the password inputted into the CPU 240 of the notebook-sized personal computer by the user constitute input authentication information which is inputted for the authentication process.

The CPU 240 of the notebook-sized personal computer serves as authentication information transmitting means for transmitting the input authentication information to the non-subscriber stations connected by the sender-receiver unit 210.

The subscriber station device 300 comprises: a router 310 for connecting to the non-subscriber station devices 400 and 500 by way of a high-speed communication line such as an internet or a leased line; an authentication server 320 serving as registered information storing means for storing a registered authentication information; and an accounting server 330 for running an accounting process.

The non-subscriber station devices 400 and 500 respectively comprise: sender-receiver units 410 and 510 for connecting to the CATV mobile terminal device 200 by wireless; routers 420 and 520 for connecting to the subscriber station device 300 or the other non-subscriber station devices by a high-speed communication line such as an internet or a leased line; animation servers 430 and 530 serving as delivering means for delivering the contents of animation data such as a movie, music, weather information, and news; authentication servers 440 and 540 serving as acquired information storing means for acquiring the registered authentication information stored by the authentication server 320 of the subscriber station device 300 to store the acquired registered authentication information therein for a predetermined duration, e.g., one day; and CATV video transmission units 460 and 560 serving as delivering means for delivering contents by CATV digital video signal such as an MPEG format.

The authentication servers 440 and 540 serves as: acquired information authentication means for carrying out an authentication process of authenticating the user of the CATV mobile terminal device 200 on the basis of the input authentication information transmitted from the CPU 240 of the notebook-sized personal computer of the CATV mobile terminal device 200; delivery permitting means for permitting the animation servers 430 and 530 or the CATV video transmission units 460 and 560 to deliver the contents to the CATV mobile terminal device 200 through the sender-receiver unit 210 when the user of the CATV mobile terminal device 200 can be authenticated; and authentication information transferring means for transferring, to the subscriber station device 300, the input authentication information which is transmitted from the CPU 240 of the notebook-sized personal computer of the CATV mobile terminal device 200.

The authentication server 320 of the subscriber station device 300 serves as transfer information authentication means for carrying out an authentication process of authenticating the user of the CATV mobile terminal device 200 on the basis of the stored registered authentication information and the input authentication information transmitted from the authentication servers 440 and 540 of the non-subscriber station devices 400 and 500.

The subscriber station device 300 is designed to transmit the result of the authentication process to the non-subscriber station device 400 only when the user of the CATV mobile terminal device 200 can be authenticated by the authentication server 320.

The authentication servers 440 and 540 of the non-subscriber station devices 400 and 500 are designed to acquire the registered authentication information stored by the authentication server 320 of the subscriber station device 300 to store the acquired registered authentication information when the user of the CATV mobile terminal device 200 can be authenticated by the authentication server 320 of the subscriber station device 300.

Secondly, the operation of the cable television system according to the present invention will be described hereinafter.

The authentication server 320 of the subscriber station device 300 is operated, as not shown in the drawings, to perform a registered information storing step of previously storing the registered authentication information of the user of the CATV mobile terminal device 200.

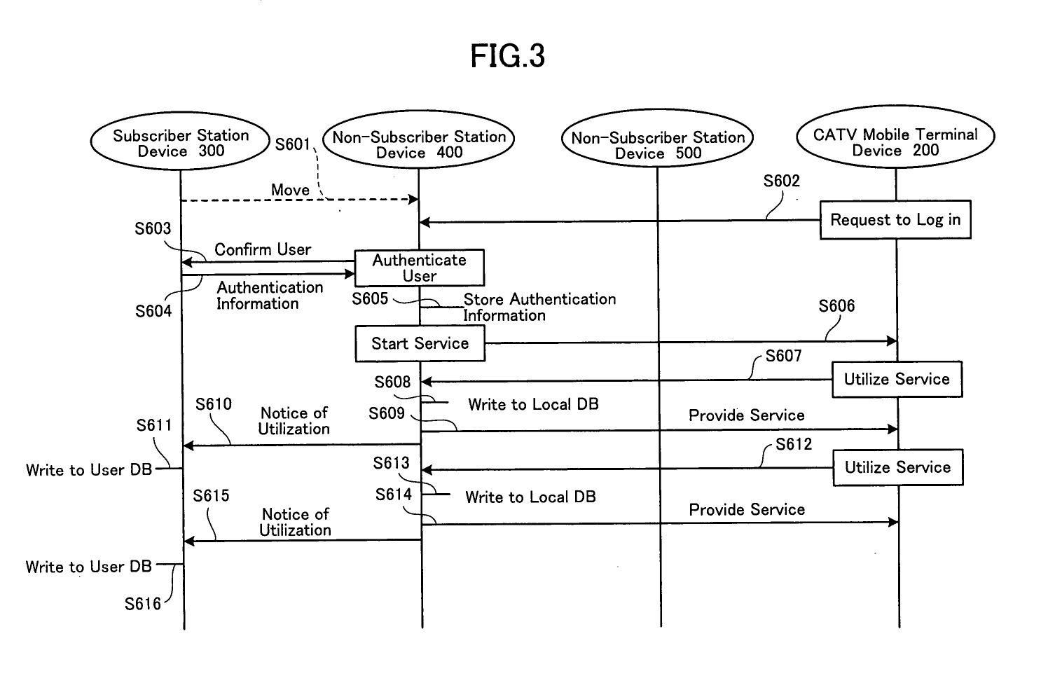

As shown in FIG. 3, the CATV mobile terminal device 200 moves from one service area of the CATV station, in which the subscriber station device 300 is installed, to the other service area of the CATV station, in which the non-subscriber station device 400 is installed, in the step S601. When the CPU 240 of the notebook-sized personal computer of the CATV mobile terminal device 200 is operated to allow the user to input a request to log in, the CPU 240 of the notebook-sized personal computer of the CATV mobile terminal device 200 is operated to perform a wireless connecting step of connecting thereto the sender-receiver unit 410 of the non-subscriber station device 400 by way of the sender-receiver unit 210 and then to perform an authentication information transmitting step of transmitting the input authentication information, i.e., information read from the IC card by the IC card reader, and a password inputted by the user, to the connected non-subscriber station device 400, in the step S602.

When the input authentication information is transmitted from the CATV mobile terminal device 200 to the sender-receiver unit 410, the authentication server 440 of the non-subscriber station device 400 is operated to store the transmitted input authentication information, to confirm that the user of the CATV mobile terminal device 200 is not registered thereon on the basis of the stored input authentication information, and to then transmit the transmitted input authentication information to the subscriber station device 300 through the router 420 to confirm whether the user of the CATV mobile terminal device 200 is registered on the subscriber station device 300 or not, in the step S603.

When the input authentication information is transmitted to the router 310 by the authentication server 440 of the non-subscriber station device 400, the authentication server 320 of the subscriber station device 300 is operated to perform an authentication process of authenticating the user of the CATV mobile terminal device 200 on the basis of the transmitted input authentication information and the stored registered authentication information to then get the user of the CATV mobile terminal device 200 authenticated.

The authentication server 320 is then operated to transmit the result of the authentication process to the non-subscriber station device 400 through the router 310.

When the result of the authentication process obtained by the authentication server 320 of the subscriber station device 300 is transmitted to the router 420, the authentication server 440 of the non-subscriber station device 400 is operated to make the judgment that the user of the CATV mobile terminal device 200 is authenticated by the authentication server 320 of the subscriber station device 300 on the basis of the transmitted result of the authentication process, and to then perform an acquired information storing process including the steps of: acquiring the registered authentication information stored by the authentication server 320 of the subscriber station device 300 through the router 420, in the step S604; and storing therein the acquired registered authentication information, in the step S605.

The authentication server 440 is operated to notice the CATV mobile terminal device 200, through the sender-receiver unit 410, that the service can be provided, in the step S606.

When the sender-receiver unit 210 receives the notice that it is possible to provide the service from the authentication server 440 of the non-subscriber station device 400, and the CPU 240 of the notebook-sized personal computer of the CATV mobile terminal device 200 accepts a user request to receive the contents inputted by the user, the CPU 240 of the notebook-sized personal computer of the CATV mobile terminal device 200 is operated to notice the non-subscriber station device 400 through the sender-receiver unit 210 that a user requests to utilize the service for delivering the contents, in the step S607.

The non-subscriber station device 400 is operated to receive the notice from the subscriber station device 300 by way of the sender-receiver unit 410, to then have the accounting server 450 write delivery historical information representative of a history of delivering the contents into a local database of the accounting server 450, in the step S608, and further to have the animation server 430 or the CATV video transmission unit 460 perform a delivery process of delivering the contents, which are required by the CATV mobile terminal device 200, to the CATV mobile terminal device 200 through the sender-receiver unit 410, so as to provide a service for the CATV mobile terminal device 200, in the step S609.

When the contents from the animation server 430 of the non-subscriber station device 400 is received by the sender-receiver unit 210, the CPU 240 of the notebook-sized personal computer of the CATV mobile terminal device 200 is operated to have the display 230 display the received contents and to record delivery receipt historical information representative of a history of receiving the delivered contents.

When the contents are received from the CATV video transmission unit 460 of the non-subscriber station device 400 by the sender-receiver unit 210, the D-STB 250 of the CATV mobile terminal device 200 is operated to receive a signal of a designated channel to transform the received signal into a video, to allow the display 230 to display the contents of the transformed video, and then to have the CPU 240 of the notebook-sized personal computer record the delivery receipt historical information thereon.

After the non-subscriber station device 400 is operated to provide the service for the CATV mobile terminal device 200, the non-subscriber station device 400 is operated to notice the subscriber station device 300 through the router 420 that the user of the CATV mobile terminal device 200 has utilized the service, in the step S610.

The subscriber station device 300 is operated to receive the notice from the non-subscriber station device 400 through the router 310 and then to have the accounting server 330 write the delivery historical information into the user database which is stored in the accounting server 330, in the step 611.

The cable television system 100 is operated to perform the process including the steps S612 to S616 which are similar to the steps S607 to S611, respectively, when the user request to receive the contents is inputted again to the CPU 240 of the notebook-sized personal computer of the CATV mobile terminal device 200 by the user.

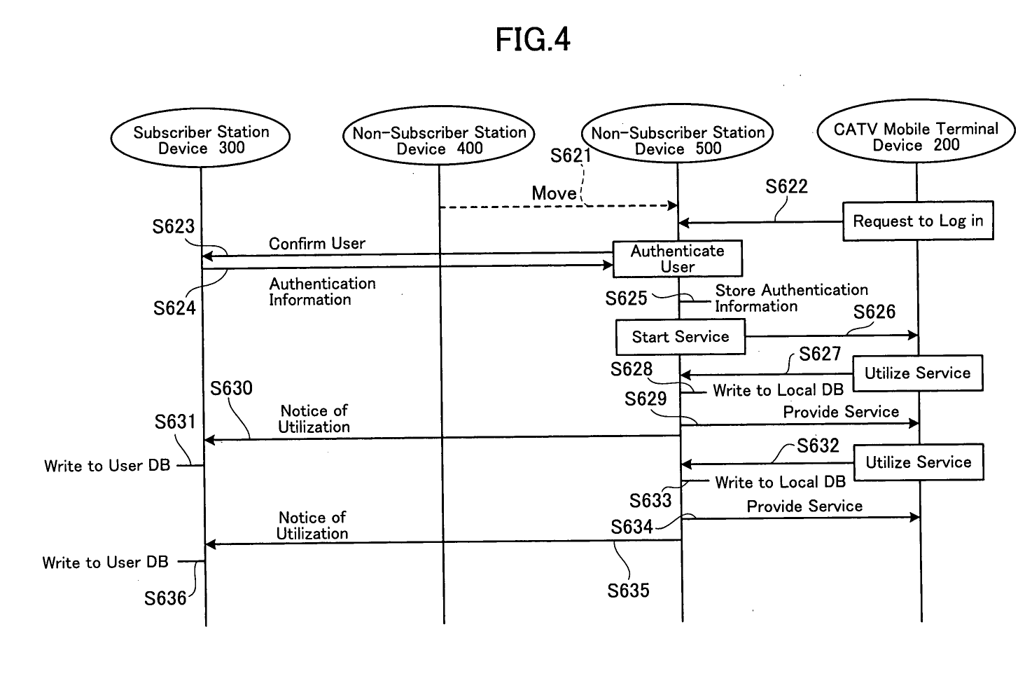

The cable television system 100 is further operated to perform the process including the steps S621 to S636 as shown in FIG. 4 similar to the steps S601 to S616, when the vehicle having the CATV mobile terminal device 200 mounted thereon moves from one service area of the CATV station, in which the non-subscriber station device 400 is installed, to the other service area of the CATV station, in which the non-subscriber station device 500 is installed.

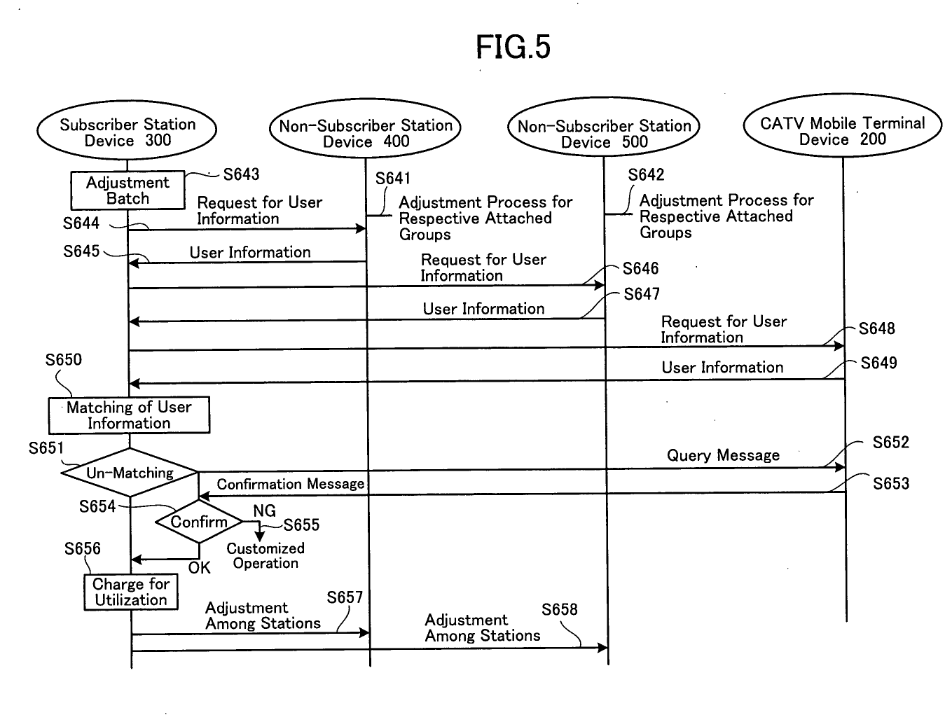

As shown in FIG. 5, the non-subscriber station devices 400 and 500 have the delivery historical information assembled into different groups of the CATV stations, in the steps S641 and S642, respectively. Each of the CATV stations subscribed by the users having the service provided belongs to any one of the groups.

The accounting server 330 of the subscriber station device 300 is operated to perform the adjustment batch, in the step S643, and to then request the non-subscriber station devices 400 and 500 and the CATV mobile terminal device 200 for the utilization information, such as the delivery historical information and the delivery receipt historical information, in the steps S644, S646 and S648. The non-subscriber station devices 400 and 500 and the CATV mobile terminal device 200 are then operated to transmit the stored delivery historical information and the stored delivery receipt historical information to the subscriber station device 300, in the steps S645, S647, and S649.

When the delivery historical information and the delivery receipt historical information are transmitted from the non-subscriber station devices 400 and 500 and the CATV mobile terminal device 200, the accounting server 330 of the subscriber station device 300 is operated to perform the utilization information matching step of comparing the delivery historical information transmitted from the non-subscriber station devices 400 and 500 with the delivery receipt historical information transmitted from the CATV mobile terminal device 200, in the step S650, to then judge whether the delivery historical information is unmatched with to the delivery receipt historical information or not, in the step S651.

When the accounting server 330 is operated to judge that the delivery historical information is unmatched with the delivery receipt historical information, the accounting server 330 is operated to send the query message to the CATV mobile terminal device 200, in the step S652.

In the response to the query message transmitted from the accounting server 330 to the CATV mobile terminal device 200, the CPU 240 of the notebook-sized personal computer of the CATV mobile terminal device 200 is operated to allow the user of the CATV mobile terminal device 200 to input the confirmation message. When the confirmation message is inputted by the user, the CATV mobile terminal device 200 is operated to transmit the inputted confirmation message to the subscriber station device 300, in the step 635.

The accounting server 330 of the subscriber station device 300 is operated to judge whether the justice of the delivery historical information can be confirmed by the confirmation message transmitted from the CATV mobile terminal device 200 or not, in the step S654. When the judgment is made that the justice cannot be confirmed, the accounting server 330 of the subscriber station device 300 is operated to customize the accounting corresponding to the delivery historical information which cannot be confirmed, in the step S655.

When the judgment is made that the delivery historical information is not unmatched with the delivery receipt historical information in the step S651, or that the justice of the delivery historical information can be confirmed in the step S655, the accounting server 330 is operated to charge for the utilization of the service provided by the non-subscriber station devices 400 and 500, in the step S656. Thereafter, the accounting server 330 is operated to balance accounts with the non-subscriber station devices 400 and 500, in the steps S657 and S658.

When the authentication servers 440 and 540 of the non-subscriber station devices 400 and 500 are operated to keep the registered authentication information acquired from the authentication server 320 in the steps S604 and S624, and to receive the input authentication information from the CATV mobile terminal device 200, not shown in the drawings, the authentication servers 440 and 540 of the non-subscriber station devices 400 and 500 are operated to perform the acquired information authentication step of performing by themselves the authentication process of authenticating the user of the CATV mobile terminal device 200 on the basis of the received input authentication information and the stored registered authentication information, so as to confirm that the user of the CATV mobile terminal device 200 has been registered in the subscriber station device 300.

The authentication servers 440 and 540 of the non-subscriber station devices 400 and 500 are then operated to perform the delivery permitting step of permitting the animation servers 430 and 530 or the CATV video transmission units 460 and 560 to deliver the contents to the CATV mobile terminal device 200 when the user of the CATV mobile terminal device 200 can be authenticated in the acquired information authentication step. These operations are similar to those of the steps S606 and S626.

As described above, the cable television system 100 can have the non-subscriber station devices 400 and 500 installed in the non-subscriber stations perform the authentication process of authenticating the user of the CATV mobile terminal device 200, thereby making it possible to have the non-subscriber stations provide the CATV service to the CATV mobile terminal device 200.

The cable television system 100 can further have the non-subscriber station devices 400 and 500 store the registered authentication information acquired from the subscriber station device 300 and then perform by themselves the authentication process of authenticating the user of the CATV mobile terminal device 200 on the basis of the registered authentication information stored in the non-subscriber station devices 400 and 500, thereby reducing the number of times of the communication between the subscriber station and the non-subscriber station in comparison with that in case where the non-subscriber station devices 400 and 500 installed in the non-subscriber stations are operated to query the subscriber station device 300 installed in the subscriber station whenever the user of the CATV mobile terminal device 200 requests to log into the sub-subscriber station devices 400 and 500 installed in the non-subscriber stations.

In this embodiment, the authentication servers 440 and 540 of the non-subscriber station devices 400 and 500 are operated to acquire the registered authentication information stored from the authentication server 320 of the subscriber station device 300 and to then store the acquired registered authentication information when the user of the CATV mobile terminal device 200 can be authenticated by the authentication server 320 of the subscriber station device 300. As a result, the authentication servers 440 and 540 of the non-subscriber station devices 400 and 500 can query a plurality of CATV stations.

In this embodiment, the subscriber station device 300 is adapted to transmit the result of the authentication process to the non-subscriber station which has transmitted the input authentication information, only when the authentication server 320 is operated to authenticate the user of the CATV mobile terminal device 200. Therefore, the cable television system 100 is operated to select the subscriber station device 300 installed in the subscriber station which is subscribed by the user of the CATV mobile terminal device 200 from among a plurality of CATV stations to have only the selected subscriber station device 300 transmit the result of the authentication process to the non-subscriber station devices 400 and 500 when the cable television system 100 is operated to have the non-subscriber station devices 400 and 500 query a plurality of CATV stations. This results in the fact that the number of times of communication between the CATV stations is reduced in comparison with that in case where the cable television system 100 is operated to have whole of a plurality of CATV stations transmit the result of the authentication process to the non-subscriber station devices 400 and 500.

The authentication servers 440 and 540 may be operated to judge to which of the CATV stations to transfer the input authentication information when the input authentication information is received from the CPU 240 of the notebook-sized personal computer of the CATV mobile terminal device 200. In one case where the judgment can be made, on the basis of the received input authentication information, that the input authentication information should be transferred to some of the CATV stations, the authentication servers 440 and 540 may be operated to transfer the input authentication information to only the judged CATV stations. In the other case where the judgment cannot be made, on the basis of the received input authentication information, that the input authentication information should be transferred to any of the CATV stations, the authentication servers 440 and 540 may be operated to transfer the input authentication information to the subscriber station as well as the other of the non-subscriber stations. In other words, the authentication servers 440 and 540 may be adapted to transfer the input authentication information to the subscriber station device 300 on the basis of the input authentication information transmitted by the CPU 240 of the notebook-sized personal computer of the CATV mobile terminal device 200.

In this case, the cable television system 100 can be operated to have the non-subscriber station devices 400 and 500 judge which of the subscriber stations is subscribed by the user of the CATV mobile terminal device 200, on the basis of the input authentication information, and to then transfer the input authentication information to the subscriber station device 300 installed in the subscriber station which is subscribed by the user of the CATV mobile terminal device 200, thereby reducing the number of times of the communication between the CATV stations in comparison with that in case where the cable television system 100 is operated to have the non-subscriber station devices 400 and 500 transfer the input authentication information to a plurality of CATV stations.

In this embodiment, the cable television system 100 can further be operated to have the authentication servers 440 and 540 of the non-subscriber station devices 400 and 500 record the registered authentication information for a predetermined duration, thereby remaining a security for the authentication process in comparison with that in case where the registered authentication information is recorded for an indefinite period.

In this embodiment, the cable television system 100 is further operated to record the input authentication information on the IC card, thereby remaining a security for the authentication process.

(A Second Embodiment)

The construction of the second embodiment of the cable television system according to the present invention will be described first. The constitutional elements of this embodiment of the cable television system similar to those of the first embodiment of the cable television system will be omitted from the following detailed description except for particular constitutional elements, which will be described hereinafter.

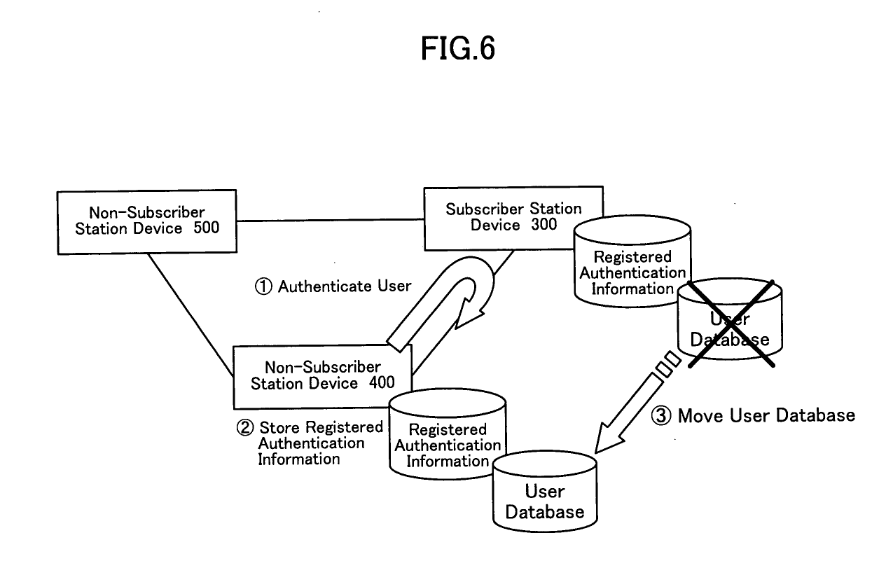

As shown in FIGS. 1 and 6, the accounting servers 450 and 550 of the non-subscriber station devices 400 and 500 in this embodiment of the cable television system 100 respectively serve as: delivery history storing means for acquiring a user database, i.e., a delivery historical file, having a set of delivery historical information from another non-subscriber station device which has been just before connected to the CATV mobile terminal device 200 by way of the sender-receiver unit 210 when the accounting servers 450 and 550 of the non-subscriber station devices 400 and 500 are connected to the CATV mobile terminal device 200 through the sender-receiver unit 210, to then store the acquired user database therein; and delivery history recording means for recording the delivery historical information on the stored user database when the animation servers 430 and 530 or the CATV video transmission units 460 and 560 are operated to deliver the contents to the CATV mobile terminal device 200 connected by the sender-receiver unit 210.

The accounting server 330 of the subscriber station device 300 serves as accounting means for performing an accounting process on the basis of the delivery historical information of the user database stored by the accounting servers 450 and 550 of the non-subscriber station devices 400 and 500. Therefore, the subscriber station device 300 serves as an accounting device.

The CPU 240 of the notebook-sized personal computer of the CATV mobile terminal device 200 further serves as instruction information inputting means for inputting thereto recording method instruction information to instruct, to the non-subscriber station device 400, a recording method of recording thereon the delivery historical information.

The accounting server 330 of the subscriber station device 300 further serves as connection information acquiring means for acquiring location information as connected device information indicative of the non-subscriber station device connected to the CATV mobile terminal device 200 through the sender-receiver unit 210.

The accounting server 330 of the subscriber station device 300 further serves as last connected device judging means for judging which of the non-subscriber station devices was connected last to the CATV mobile terminal device 200 through the sender-receiver unit 210 on the basis of the acquired connected device information.

The accounting server 330 is adapted to perform the accounting process on the basis of the delivery historical information of the user database stored by the accounting server of the non-subscriber station device which is judged to be the non-subscriber station that has been just before connected to the CATV mobile terminal device 200 through the sender-receiver unit 210.

The accounting servers 450 and 550 of the non-subscriber station devices 400 and 500 are adapted to record the delivery historical information in accordance with: a contents delivery situation indicative how the contents are delivered from the animation servers 430 and 530 or the CATV video transmission units 460 and 560 to the CATV mobile terminal device 200 connected by the sender-receiver unit 210; or the recording method instruction information inputted by the CPU 240 of the notebook-sized personal computer of the CATV mobile terminal device 200.

Secondly, the operation of this embodiment of the cable television system will be described hereinafter.

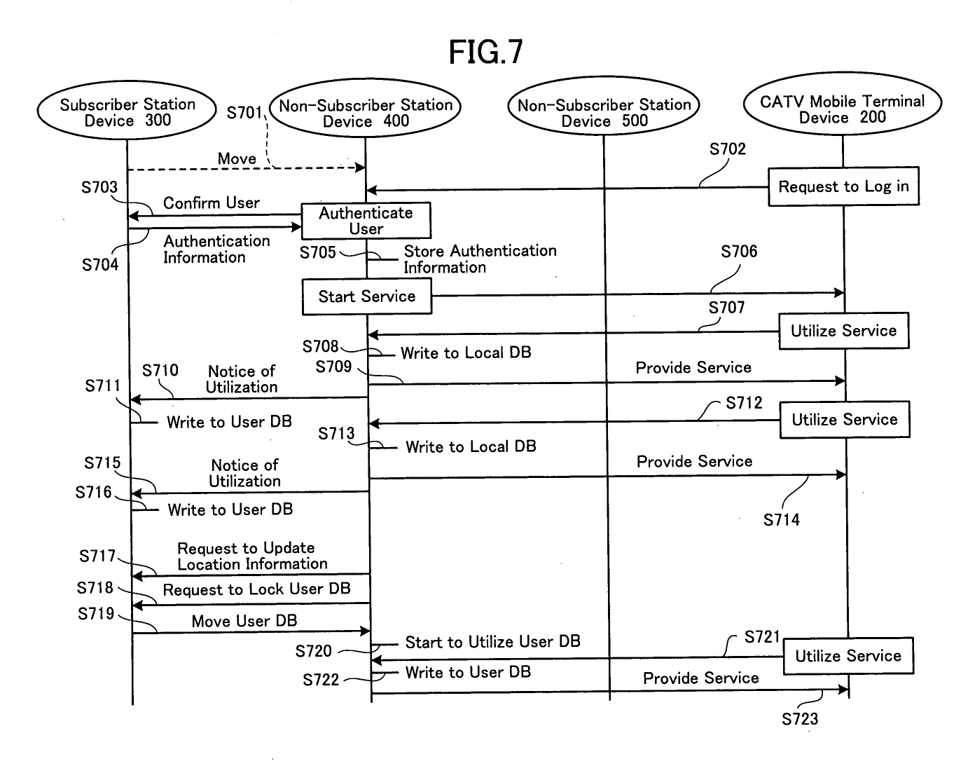

The cable television system 100 is operated to perform the processes in the steps S701 to S716 as shown in FIG. 7 which are similar to those of the steps S601 to 616 shown in FIG. 3, when the vehicle having the CATV mobile terminal device 200 mounted thereon moves from one service area of the CATV station, in which the subscriber station device 300 is installed, to the other service area of the CATV station, in which the non-subscriber station device 400 is installed.

In this embodiment, the accounting server 450 of the non-subscriber station device 400 is operated, in the step S704, to receive also the location information including “the subscriber station device 300” from the accounting sever 330 of the subscriber station device 300. The accounting server 450 of the non-subscriber station device 400 is further operated, in the steps S710 and S715, to transmit the utilization notice to the subscriber station device which is recorded on the location information, and then, in the steps S711 and S716, to record the delivery historical information onto the user database stored in the subscriber station device 300 which is recorded on the location information.

The accounting server 450 of the non-subscriber station device 400 is operated to transmit a request to update the location information to the subscriber station device 300 through the router 420, in the step S717, when the contents delivery situation indicative how the contents are delivered from the animation severs 430 or the CATV video transmission unit 460 to the CATV mobile terminal device 200 connected by the sender-receiver unit 210 becomes a predetermined situation, or when the recording method instruction information is inputted to the CPU 240 of the notebook-sized personal computer of the CATV mobile terminal device 200 so as to change the recording method of the delivery historical information by request of the user of the CATV mobile terminal device 200.

When the request to update the location information is transmitted from the accounting server 450 of the non-subscriber station device 400 to the router 310, the accounting server 330 of the subscriber station device 300 is operated to update the location information from “the subscriber station device 300” to “the non-subscriber station device 400” on the basis of the transmitted request to update the location information.

After the request to update the location information is transmitted to the subscriber station device 300, the accounting server 450 of the non-subscriber station device 400 is operated to transmit a user database lock request to protect the delivery historical information of the user database against the alteration, to the subscriber station device 300, which is recorded on the previous location information before updating, through the router 420, in the step S718.

When the user database lock request is transmitted from the accounting server 450 of the non-subscriber station device 400 to the router 310, the accounting server 330 of the subscriber station device 300 is operated to protect the delivery historical information of the user database against the alteration in accordance with the transmitted user database lock request, and to move the user database to the accounting server 450 of the non-subscriber station device 400 through the router 310, in the step S719.

The accounting server 450 of the non-subscriber station device 400 is then operated to store the moved user database therein, and to start the use of the stored user database, in the step S720.

When a request to receive the contents is inputted by the user, the CPU 240 of the notebook-sized personal computer of the CATV mobile terminal device 200 is operated to notice the non-subscriber station device 400 through the sender-receiver unit 210 that the user requests to utilize the service for delivering the contents, in the step S721.

The non-subscriber station device 400 is operated to receive the notice from the CATV mobile terminal device 200 through the sender-receiver unit 410, to have the accounting server 450 record the delivery historical information indicative of the history of the delivered contents onto the user database of the accounting server 450, in the step S722, and thereafter to have the animation server 430 or the CATV video transmission unit 460 perform a delivering step of delivering the contents, which is noticed by the CATV mobile terminal device 200, to the CATV mobile terminal device 200 through the sender-receiver unit 410, so as to provide the service for the CATV mobile terminal device 200, in the step S723.

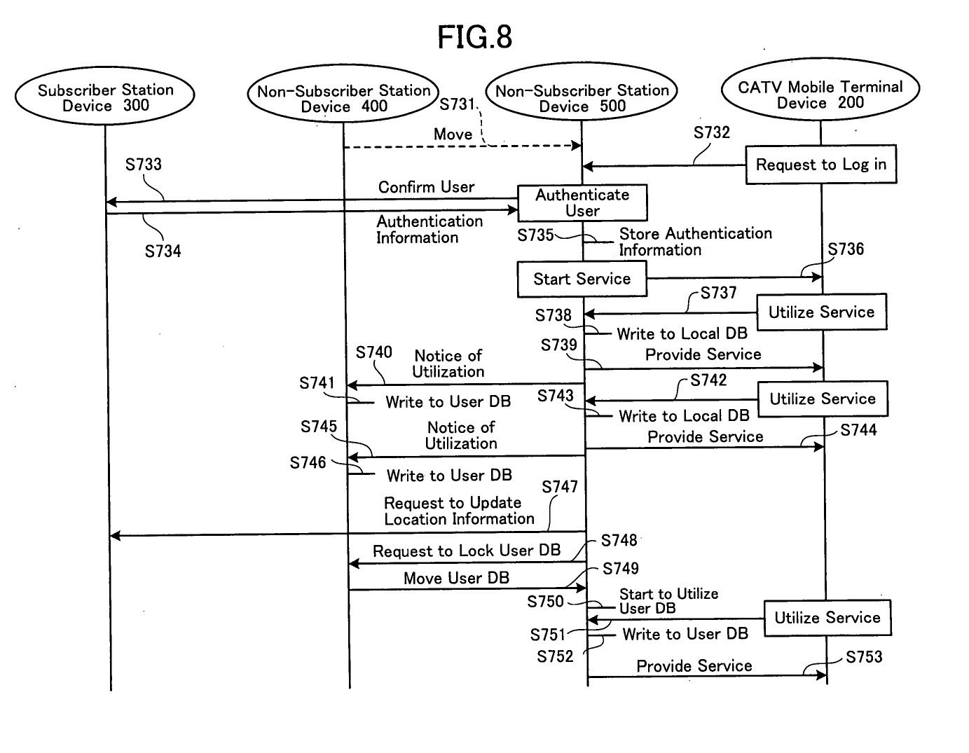

The cable television system 100 is further operated to perform the processes in the steps S731 to S746 as shown in FIG. 8 which are similar to those of the steps S701 to S716, when the vehicle having the CATV mobile terminal device 200 mounted thereon moves from one service area of the CATV station, in which the non-subscriber station device 400 is installed, to the other service area of the CATV station, in which the non-subscriber station device 500 is installed.

The accounting server 450 of the non-subscriber station device 400 is operated, in the step S734, to receive also the location information including “the non-subscriber station device 400” from the accounting server 330 of the subscriber station device 300. The accounting server 450 of the non-subscriber station device 400 is further operated, in the step S740 or S745, to transmit the utilization information to the non-subscriber station device 400 which is recorded on the location information, and then, in the step S741 or S746, to record the delivery historical information onto the user database stored in the non-subscriber station device 400 which is recorded on the location information.

The accounting server 550 of the non-subscriber station device 500 is operated to transmit the request to update the location information to the subscriber station device 300 through the router 520, in the step S747, when the contents delivery situation indicative how the contents are delivered from the animation severs 530 or the CATV video transmission unit 560 to the CATV mobile terminal device 200 connected by the sender-receiver unit 210 becomes a predetermined situation, or when the recording method instruction information is inputted to the CPU 240 of the notebook-sized personal computer of the CATV mobile terminal device 200 so as to change the recording method of the delivery historical information by request of the user of the CATV mobile terminal device 200.

When the request to update the location information is transmitted from the accounting server 550 of the non-subscriber station device 500 to the router 310, the accounting server 330 of the subscriber station device 300 is operated to update the location information from “the non-subscriber station device 400” to “the non-subscriber station device 500” on the basis of the transmitted request to update the location information.

After the request to update the location information is transmitted to the subscriber station device 300, the accounting server 550 of the non-subscriber station device 500 is operated to transmit the user database lock request to protect the delivery historical information of the user database against the alteration, to the subscriber station device 300, which is recorded on the previous location information before updating, through the router 520, in the step S748.

When the user database lock request is transmitted from the accounting server 550 of the non-subscriber station device 500 to the router 310, the accounting server 330 of the subscriber station device 300 is operated to protect the delivery historical information of the user database against the alteration in accordance with the transmitted user database lock request, and to move the user database to the accounting server 550 of the non-subscriber station device 500 through the router 310, in the step S749.

The accounting server 550 of the non-subscriber station device 500 is then operated to perform a delivery history storing step of storing the moved user database therein, and then to start the use of the stored user database, in the step S750.

When the request to receive the contents is inputted by the user, the CPU 240 of the notebook-sized personal computer of the CATV mobile terminal device 200 is operated to notice the non-subscriber station device 500 through the sender-receiver unit 210 that the user requests to utilize the service for delivering the contents, in the step S751.

The non-subscriber station device 500 is operated to receive the notice from the CATV mobile terminal device 200 through the sender-receiver unit 510, to have the accounting server 550 perform a delivery history recording step of recording the delivery historical information indicative of the history of the delivered contents onto the user database of the accounting server 550, in the step S752, and thereafter to have the animation server 530 or the CATV video transmission unit 560 perform the delivering step of delivering the contents, which is noticed by the CATV mobile terminal device 200, to the CATV mobile terminal device 200 through the sender-receiver unit 510, so as to provide the service for the CATV mobile terminal device 200, in the step S753.

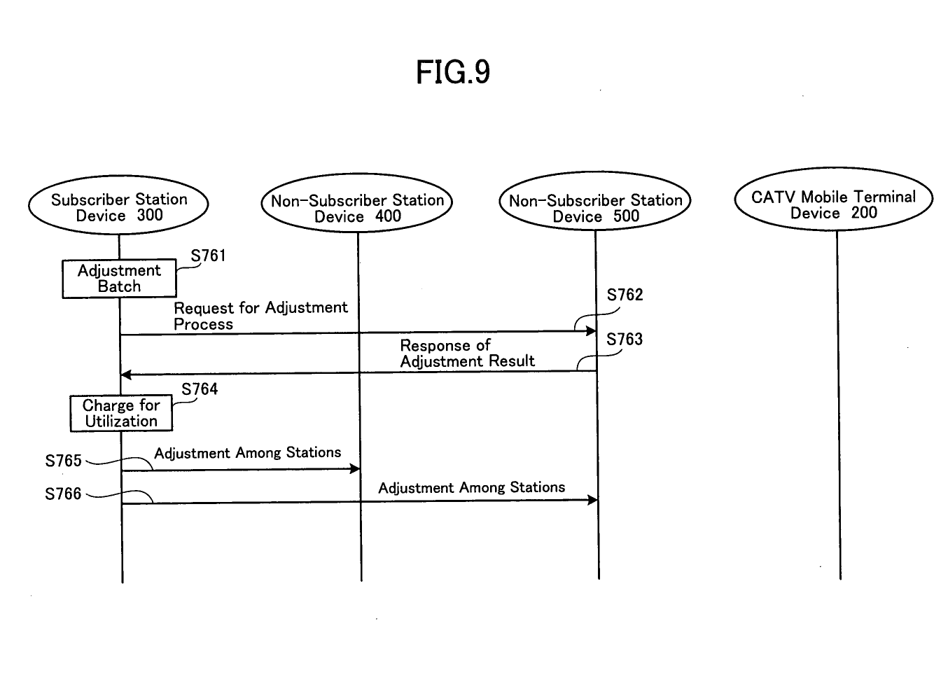

As shown in FIG. 9, the accounting server 330 of the subscriber station device 300 is operated to perform the adjustment batch, in the step S761, and then to request the non-subscriber station device 500, which is recorded on the location information, for the utilization information, such as delivery historical information, in the step S762. The non-subscriber station device 500 is then operated to transmit the stored delivery historical information to the subscriber station device 300, in the step S763.

The accounting server 330 is then operated to perform an accounting step of charging the user of the CATV mobile terminal device 200 for the utilization of the service provided by the non-subscriber station devices 400 and 500, in the step S764, thereafter to balance accounts with the non-subscriber station devices 400 and 500, in the steps S765 and S766.

As described above, the cable television system 100 can have the non-subscriber stations provide the CATV service for the CATV mobile terminal device 200, because of the fact that the subscriber station device 300 installed in the subscriber station can charge the user of the CATV mobile terminal device 200 a fee, even when the non-subscriber station devices 400 and 500 installed in the non-subscriber stations are operated to provide the CATV service for the CATV mobile terminal device 200.

The cable television system 100 is adapted to have the non-subscriber station devices 400 and 500 record the delivery historical information onto the user databases stored in the non-subscriber station devices 400 and 500 by themselves, whenever the contents are delivered to the CATV mobile terminal device 200 by the non-subscriber station devices 400 and 500, respectively. The cable television system 100 is further adapted to have the subscriber station device 300 perform the accounting process on the basis of the delivery historical information recorded, by the non-subscriber station devices 400 and 500 themselves, onto the user databases stored in the non-subscriber station devices 400 and 500, respectively. This results in the fact that it is unnecessary for the subscriber station device 300 to acquire the delivery historical information from the non-subscriber station devices 400 and 500, whenever the non-subscriber station devices 400 and 500 deliver the contents to the CATV mobile terminal device 200.

The cable television system 100 can therefore reduce the number of times of the communication between the subscriber station device 300 installed in the subscriber station and the non-subscriber station devices 400 and 500 installed in the non-subscriber stations when the non-subscriber station devices 400 and 500 installed in the non-subscriber stations are operated to provide the CATV service for the CATV mobile terminal device 200 as represented by the processes in the steps S721 to S723 and steps S751 to S753 in comparison with that in the case where the cable television system 100 is operated to have the subscriber station device 300 acquire the delivery historical information from the non-subscriber station devices 400 and 500 whenever the non-subscriber station devices 400 and 500 deliver the contents to the CATV mobile terminal device 200 as represented by the processes in the steps S707 to S716 and steps S737 to S746.

The cable television system 100 is adapted to have the non-subscriber station device 500 acquire the user database from the non-subscriber device 400 which has been connected to the CATV mobile terminal device 200 just before the non-subscriber station device 500 is connected to the CATV mobile terminal device 200, and to then store the acquired user database therein. The cable television system 100 is further adapted to have the subscriber station device 300 perform the accounting process on the basis of the delivery historical information on the user database stored in the non-subscriber station device 500. This results in the fact that it is unnecessary for the subscriber station device 300 to acquire the delivery historical information on the user database from all of the non-subscriber station devices 400 and 500.

The cable television system 100 can therefore reduce the number of times of communication between the subscriber station device 300 installed in the subscriber station and the non-subscriber station devices 400 and 500 installed in the non-subscriber stations when the non-subscriber station devices 400 and 500 installed in the non-subscriber stations are operated to provide the CATV services for the CATV mobile terminal device 200 in comparison with that in the case where the cable television system 100 is operated to have the subscriber station device 300 acquire the delivery historical information from all of the non-subscriber station devices 400 and 500.

In this embodiment, the accounting server 330 of the subscriber station device 300 is adapted to judge, on the basis of the location information, that the non-subscriber station device 500 is the last connected device that has been just before connected to the CATV mobile terminal device 200 by the sender-receiver unit 210, and to perform the accounting process on the basis of the delivery historical information of the user database stored by the accounting server 550 of the judged non-subscriber station device 500. As a result, the accounting server 330 of the subscriber station device 300 can perform the accounting process on the basis of the latest delivery historical information.

In this embodiment, the accounting servers 450 and 550 of the non-subscriber station devices 400 and 500 are adapted to record the delivery historical information in accordance with the contents delivery situation indicative how the contents are delivered from the animation servers 430 and 530 or the CATV video transmission units 460 and 560 to the CATV mobile terminal device 200 through the sender-receiver unit 210, thereby making it possible to change the recording method of recording the delivery historical information in accordance with the contents delivery situation.

In this embodiment, because of the fact that the accounting servers 450 and 550 of the non-subscriber station devices 400 and 500 are designed to record the delivery historical information in accordance with the recording method instruction information which is inputted by the CPU 240 of the notebook-sized personal computer, the cable television system 100 can be operated to allow the user of the CATV mobile terminal device 200 to specify the recording method of recording the delivery historical information for the non-subscriber station devices 400 and 500, and then to have the non-subscriber station devices 400 and 500 record the delivery historical information thereon by the recording method which is specified by the user of the CATV mobile terminal device 200.

The CPU 240 of the notebook-sized personal computer of the CATV mobile terminal device 200 may comprise: delivery receipt history storing means for storing a delivery receipt historical file representative of an assembly of delivery receipt historical information; and delivery receipt history recording means for recording delivery receipt historical information on the stored delivery receipt historical file when the contents are delivered by the animation servers 430and 530 or the CATV video transmission units 460 and 560 of the non-subscriber station devices 400 and 500 which are connected by the sender-receiver unit 210, which are similar to those of the CPU 240 of the notebook-sized personal computer in the first embodiment. The accounting server 330 of the subscriber station device 300 may further comprise matching means for matching between the histories concerning the delivered contents on the basis of the delivery historical information of the user database to be stored and the delivery receipt historical information of the delivery receipt historical file stored by the CPU 240 of the notebook-sized personal computer of the CATV mobile terminal device 200, which is similar to that of the accounting server 330 in the first embodiment.

In that case, the cable television system 100 can be operated to have the subscriber station device 300 detect an error of the histories concerning the delivered contents, thereby improving reliability of the accounting in comparison with that in the case where the error of the histories is not detected.

The accounting server 330 of the subscriber station device 300 may comprise error information transmitting means for transmitting a query message indicative that there is an error in the histories concerning the delivered contents, i.e., history error information, to the CATV mobile terminal device 200 when the judgment is made that there the history concerning the delivered contents is false, which is similar to that of the accounting server 330 in the first embodiment.

In that case, the cable television system 100 can improve reliability of the accounting in comparison with that in the case where the notice that there is an error in the histories concerning the delivered contents is not given to the user of the CATV mobile terminal device 200, because of the fact that the cable television system 100 can be operated to have the subscriber station device 300 notice the user of the CATV mobile terminal device 200 that there is an error in the histories concerning the delivered contents when the subscriber station device 300 is operated to detect an error of the histories concerning the delivered contents.

As described above in this embodiment, the accounting server 450 of the non-subscriber station device 400 is adapted to protect the delivery historical information of the user database stored against the alteration in response to the user database lock request which is requested by the accounting server 550 of the non-subscriber station device 500, but in accordance with the present invention, the accounting servers 450 and 550 of the non-subscriber station devices 400 and 500 may comprise alteration protecting means for protecting the delivery historical information of the stored user databases against the alteration when the connection with the CATV mobile terminal device 200 is halted by the sender-receiver unit 210.

In that case, the cable television system 100 is operated to have the non-subscriber station devices, only which are operated to deliver the contents to the CATV mobile terminal device 200, alter the delivery historical information, thereby making it possible to improve reliability of the accounting in comparison with that in the case where the cable television system 100 is operated to have any non-subscriber station devices besides some non-subscriber station devices, which are not operated to deliver the contents to the CATV mobile terminal device 200, alter the delivery historical information.

(A Third Embodiment)

The construction of the third embodiment of the cable television system according to the present invention will be described first. The constitutional elements of this embodiment of the cable television system similar to those of the first embodiment of the cable television system will be omitted from the following detailed description except for the particular constitutional elements, which will be described hereinlater.

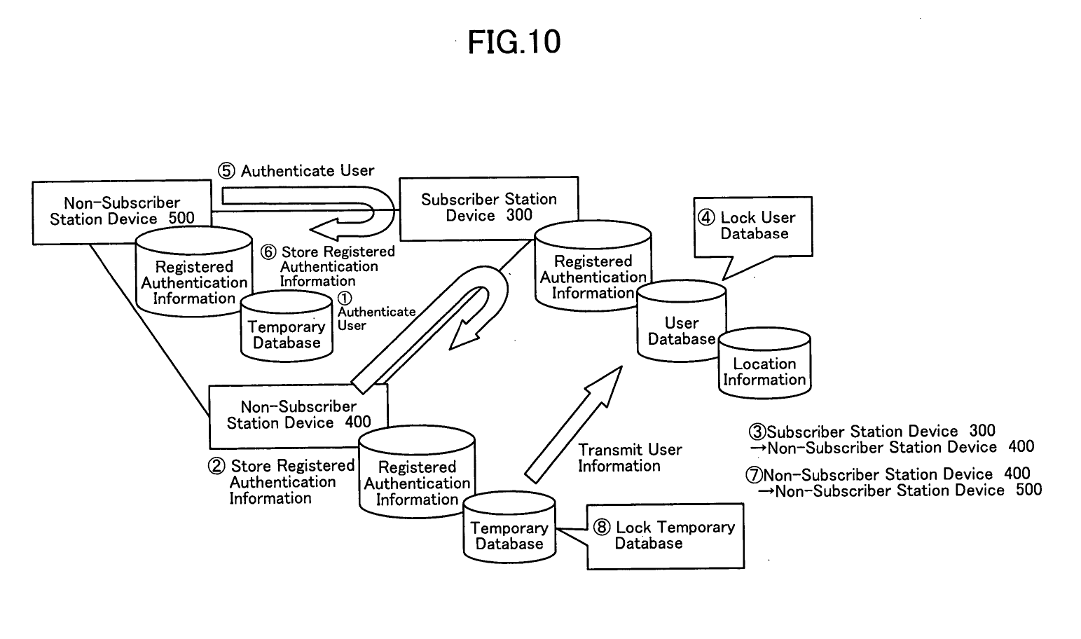

As shown in FIGS. 1 and 10, the accounting servers 450 and 550 of the non-subscriber station devices 400 and 500 in this embodiment of the cable television system 100 respectively serve as: delivery history storing means for acquiring a temporary database, i.e., delivery historical file, having a set of delivery historical information, to then store the acquired temporary database therein; and delivery history recording means for recording the delivery historical information on the stored temporary database when the animation servers 430 and 530 or the CATV video transmission units 460 and 560 are operated to deliver the contents to the CATV mobile terminal device 200 connected by the sender-receiver unit 210.

The accounting server 330 of the subscriber station device 300 serves as: history accumulating means for accumulating the delivery historical information of a plurality of temporary databases stored by the accounting servers 450 and 550 of the non-subscriber station devices 400 and 500; and accounting means for performing the accounting process on the basis of the accumulated delivery historical information. Therefore, the subscriber station device 300 serves as an accounting device.

The CPU 240 of the notebook-sized personal computer of the CATV mobile terminal device 200 further serves as: delivery receipt history storing means for storing a delivery receipt historical file representative of an assembly of delivery receipt historical information; and delivery receipt history recording means for recording delivery receipt historical information on the stored delivery receipt historical file when the contents are delivered by the animation severs 430 and 530 or the CATV video transmission units 460 and 560 of the non-subscriber station devices 400 and 500 which are connected by the sender-receiver unit 210.

The accounting server 330 of the subscriber station device 300 further serves as matching means for matching between the histories concerning the delivered contents on the basis of the accumulated delivery historical information and the delivery receipt historical information of the delivery receipt historical file stored by the CPU 240 of the notebook-sized personal computer of the CATV mobile terminal device 200.

The accounting server 330 of the subscriber station device 300 further serves as error information transmitting means for transmitting a query message indicative that there is an error of the histories concerning the delivered contents, i.e., history error information, when the judgment is made that there is an error in the histories concerning the delivered contents.

The accounting server 300 of the subscriber station device 300 further serves as connection information acquiring means for acquiring location information as connected device information indicative of the non-subscriber station device connected to the CATV mobile terminal device 200 by way of the sender-receiver unit 210.

The accounting servers 450 and 550 of the non-subscriber station devices 400 and 500 respectively serves as: last connected device judging means for judging which of the non-subscriber station devices was connected last to the CATV mobile terminal device 200 by the sender-receiver unit 210, on the basis of the location information acquired by the accounting server 330 of the subscriber station device 300 when the accounting servers 450 and 550 of the non-subscriber station devices 400 and 500 are connected to the CATV mobile terminal device 200 by the sender-receiver unit 210; instruction information transmitting means for transmitting start instruction information, which instructs the start of operation, to accounting server of the non-subscriber station device which is judged as the non-subscriber station device that is connected last to the CATV mobile terminal device 200 by the sender-receiver unit 210; and alteration protecting means for protecting the delivery historical information of the stored temporary database against an alteration in response to transmission of the start instruction information by the other non-subscriber station devices.

Secondly, the operation of this embodiment of the cable television system will be described hereinafter.

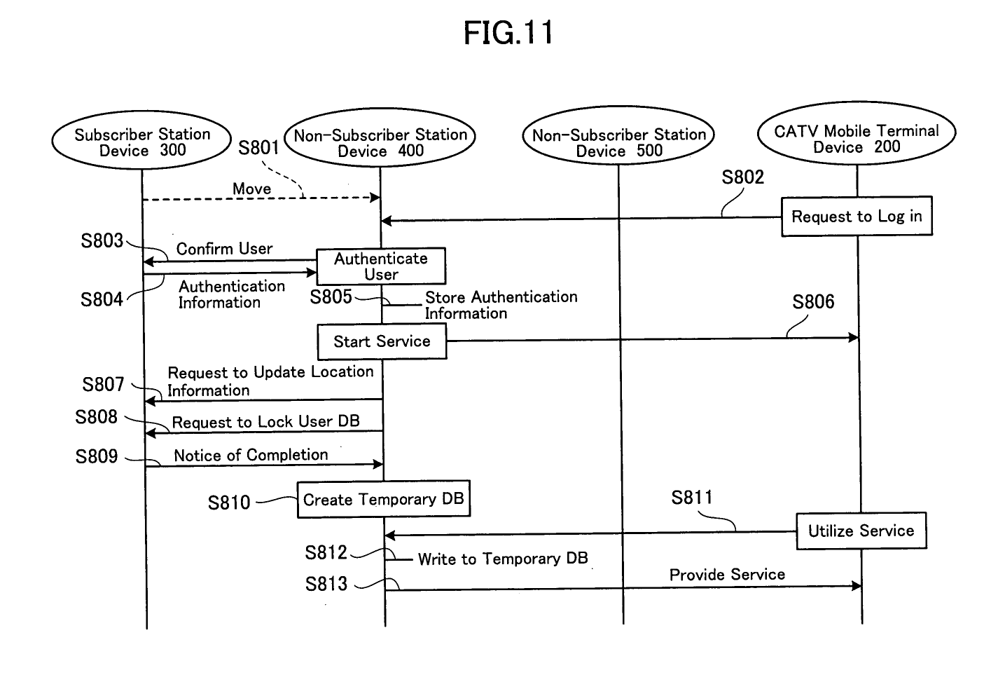

The cable television system 100 is operated to perform the processes in the steps S801 to S806 as shown in FIG. 11 which are similar to those of the steps S601 to S606 shown in FIG. 3, when the vehicle having the CATV mobile terminal device 200 mounted thereon moves from one service area of the CATV station, in which the subscriber station device 300 is installed, to the other service area of the CATV station, in which the non-subscriber station device 400 is installed.

The accounting server 450 of the non-subscriber station device 400 is operated to transmit the request for updating the location information to the subscriber station device 300 through the router 420, in the step S807.

When the request to update the location information is transmitted from the accounting server 450 of the non-subscriber station device 400 to the router 310, the accounting server 330 of the subscriber station device 300 is operated to update the location information from “the subscription station device 300” to “the non-subscriber station device 400” on the basis of the transmitted request to update the location information.

The accounting server 450 of the non-subscriber station device 400 is operated to transmit, to the subscriber station device 300 which is recorded on the location information before the updation through the router 420, the user database lock request to request to protect the delivery historical information of the user database against the alteration, in the step S808.

When the user database lock request is transmitted from the accounting server 450 of the non-subscriber station device 400 to the router 310, the accounting server 330 of the subscriber station device 300 is operated to protect the delivery historical information of the user database against the alteration in accordance with the transmitted user database lock request, and to notice the accounting server 450 of the non-subscriber station device 400 through the router 310 that the protection of the alteration in the delivery historical information of the user database is completed, in the step S809.

The accounting server 450 of the non-subscriber station device 400 is operated to perform the delivery history storing step of creating the temporary database, in the step S810.

The CPU 240 of the notebook-sized personal computer of the CATV mobile terminal device 200 is operated to notice the non-subscriber station device 400 through the sender-receiver unit 210 that the user requests to utilize the service for delivering the contents when the request for the reception of the contents is inputted by the user, in the step S811.

The non-subscriber station device 400 is operated, in the step S812, to perform the delivery history recording step of having the accounting server 450 written the delivery historical information representative of a history of delivering the contents on the temporary database of the accounting server 450, when the notice from the CATV mobile terminal device 200 is received by the sender-receiver unit 410. The non-subscriber station device 400 is further operated, in the step S813, to provide the service to the CATV mobile terminal device 200 by performing the delivery step of delivering the contents, that is notice by the CATV mobile terminal device 200, to the animation server 430 or the CATV video transmission unit 460 through the sender-receiver unit 410.

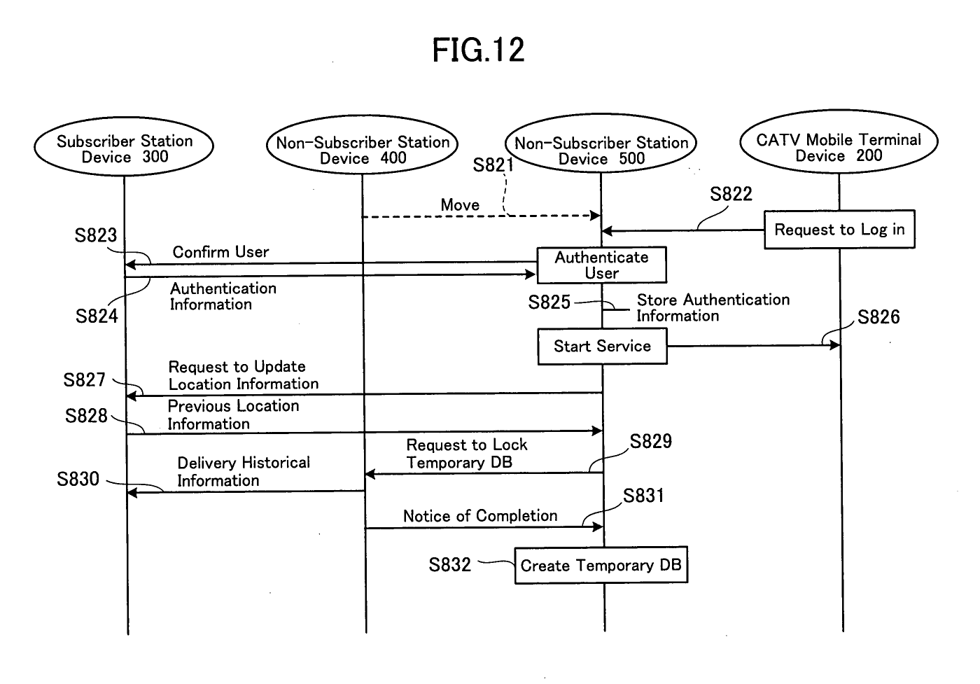

The cable television system 100 is perform the processes in the steps S821 to S826, as shown in FIG. 12, which are similar to the processes in the steps S801 to S806, respectively, when the vehicle having the CATV mobile terminal device 200 mounted thereon moves from one service area of the CATV station, in which the non-subscriber station device 400 is installed, to the other service area of the CATV station, in which the non-subscriber station device 500 is installed.

When the request to update the location information is transmitted from the accounting server 550 of the non-subscriber station device 500 to the router 310, the accounting server 330 of the subscriber station device 300 is operated to update the location information from “the non-subscriber station device 400” to “the non-subscriber station device 500” on the basis of the transmitted request to update the location information.

After the accounting server 550 of the non-subscriber station device 500 is operated to transmit the request for updating the location information to the subscriber station device 300, the accounting server 330 of the subscriber station device 300 is operated to notice the accounting server 550 of the non-subscriber station device 500 that the previous location information is “the non-subscriber station device 400”, in the step S828. Thereafter the accounting server 550 of the non-subscriber station device 500 is operated to transmit the request for the temporary database lock for preventing the alteration of the delivery historical information of the temporary database to non-subscriber station device 400 through the router 520 which is recorded on the previous location information, in the step S829.

When the request for the temporary database lock is transmitted to the router 420 by the accounting server 550 of the non-subscriber station device 500, the accounting server 450 of the non-subscriber station device 400 is operated to prevent the alteration of the delivery historical information of the temporary database on the basis of the transmitted request for the temporary database lock and to transmit the delivery historical information of the temporary database to the accounting server 330 of the subscriber station device 300 through the sender-receiver unit 410, in the step S830, and further to notice the accounting server 550 of the non-subscriber station device 500 through the router 310 that the prevention of the alteration of the delivery historical information of the temporary database is terminated, in the step S831.

The accounting server 550 of the non-subscriber station device 500 is then operated to perform the delivery history storing step of creating the temporary database, in the step S832.

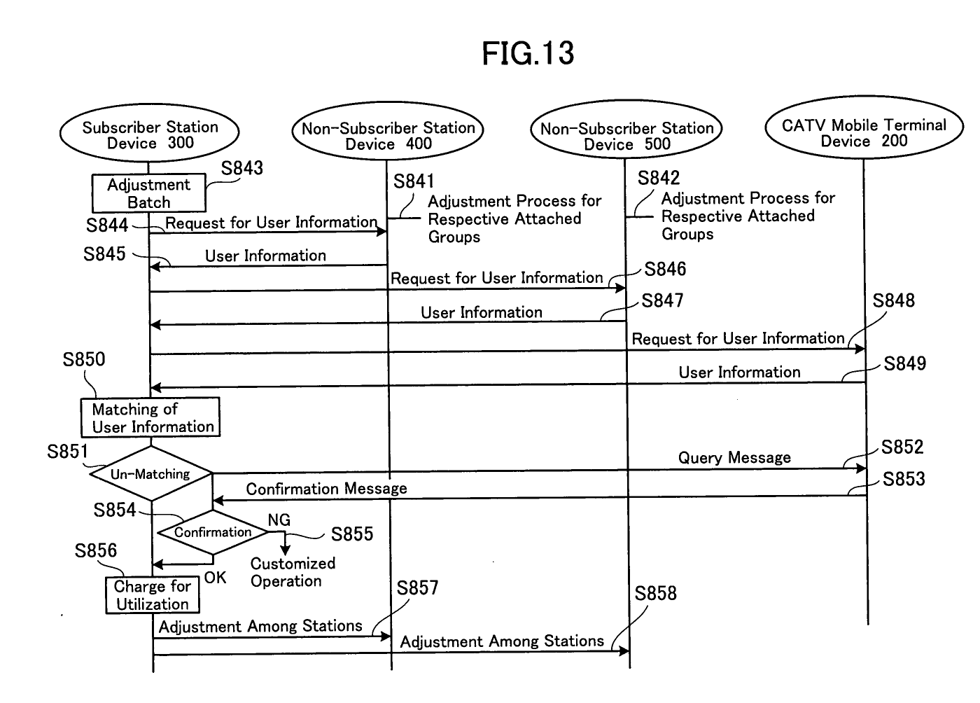

The cable television system 100 is operated to perform the processes in the steps S841 to S858 as shown in FIG. 13 which are similar to those in the steps S641 to S658, respectively, shown in FIG. 5.

In this embodiment, the process in the step S850 of matching the utilization information may include the history accumulating step of having the accounting server 330 of the subscriber station device 300 accumulate the delivery historical information of the plural temporary database stored by the accounting servers 450 and 550 of the non-subscriber station devices 400 and 500.

The process in the step S856 of charging for the utilization may include the accounting step in which the accounting server 330 of the subscriber station device 300 is operated to perform the accounting process on the basis of the accumulated delivery historical information.

As described above, the cable television system 100 can have the non-subscriber stations provide the CATV service for the CATV mobile terminal device 200, because of the fact that the subscriber station device 300 installed in the subscriber station can charge the user of the CATV mobile terminal device 200 a fee, even when the non-subscriber station devices 400 and 500 installed in the non-subscriber stations are operated to provide the CATV service for the CATV mobile terminal device 200.

The cable television system 100 is adapted to have the non-subscriber station devices 400 and 500 record the delivery historical information onto the temporary databases stored in the non-subscriber station devices 400 and 500 by themselves, whenever the contents are delivered to the CATV mobile terminal device 200 by the non-subscriber station devices 400 and 500, respectively. The cable television system 100 is further adapted to have the subscriber station device 300 perform the accounting process on the basis of the delivery historical information recorded, by the non-subscriber station devices 400 and 500 themselves, onto the temporary databases stored in the non-subscriber station devices 400 and 500, respectively. This results in the fact that it is unnecessary for the subscriber station device 300 to acquire the delivery historical information from the non-subscriber station devices 400 and 500, whenever the non-subscriber station devices 400 and 500 deliver the contents to the CATV mobile terminal device 200.

The cable television system 100 can therefore reduce the number of communication between the subscriber station device 300 installed in the subscriber station and the non-subscriber station devices 400 and 500 installed in the non-subscriber stations when CATV service is provided for the CATV mobile terminal device 200 by the non-subscriber station devices 400 and 500 installed in the non-subscriber stations, in comparison with that in the case where the subscriber station device 300 acquire the delivery historical information from the non-subscriber station devices 400 and 500 whenever the non-subscriber station devices 400 and 500 deliver the contents to the CATV mobile terminal device 200.

The cable television system 100 is adapted to have the non-subscriber station devices 400 and 500 store the temporary databases, respectively, and to have the subscriber station device 300 perform the accounting process on the basis of the delivery historical information in the plural temporary databases stored by the non-subscriber station devices 400 and 500, thereby making it unnecessary for the non-subscriber station devices 400 and 500 to acquire the temporary database from the non-subscriber station which has been just before connected to the CATV mobile terminal device 200, when the non-subscriber station devices 400 and 500 are connected to the CATV mobile terminal device 200, as described in the second embodiment.

The cable television system 100 can therefore reduce the number of times of the communications among the non-subscriber station devices installed in the plural non-subscriber stations each other, in comparison with that in the case where the cable television system 100 is operated to have the non-subscriber station devices 400 and 500 acquire the temporary database from the non-subscriber station devices which have been just before connected to the CATV mobile terminal device 200, when the non-subscriber station devices 400 and 500 are connected to the CATV mobile terminal device 200.

In this embodiment, the accounting server 330 of the subscriber station device 300 is adapted to match between the histories concerning the delivered contents on the basis of the delivery historical information accumulated and the delivery receipt historical information of the delivery receipt historical file stored by the CPU 240 of the notebook-sized personal computer of the CATV mobile terminal device 200. This results in the fact that the cable television system 100 can be operated to have the subscriber station device 300 detect an error in the histories concerning the delivered contents, thereby improving reliability in the accounting in comparison with that in the case where the error in the histories is not detected.

The accounting server 330 of the subscriber station device 300 is further adapted to transmit the query message, i.e., history error information, indicative that the histories concerning the delivered contents have an error when the judgment is made that the histories concerning the delivered contents have an error. This results in the fact that the cable television system 100 can have the subscriber station device 300 notice the user of the CATV mobile terminal device 200 that the histories have an error when the subscriber station device 300 detects the error in the histories concerning the delivered contents, thereby improving reliability in the accounting in comparison with that in the case where the subscriber station device 300 is not operated to notice the user of the CATV mobile terminal device 200 that the histories have an error.

In this embodiment, the accounting servers 450 and 550 of the non-subscriber station devices 400 and 500 are adapted to prevent the alternation in the delivery historical information of the stored temporary databases when the start instruction information is transmitted by the other non-subscriber station devices. Furthermore, the cable television system 100 is adapted to have the non-subscriber station devices, only which are operated to deliver the contents to the CATV mobile terminal device 200, alter the delivery historical information, thereby improving reliability in the accounting in comparison with that in the case where the cable television system 100 is operated to have any non-subscriber station devices besides some non-subscriber station devices, which are not operated to deliver the contents to the CATV mobile terminal device 200, alter the delivery historical information.

The accounting servers 450 and 550 of the non-subscriber station devices 400 and 500 may be adapted to record the delivery historical information in accordance with the contents delivery situation indicative how the contents are delivered from the animation servers 430 and 530 or the CATV video transmission units 460 and 560 to the CATV mobile terminal device 200 connected by the sender-receiver unit 210, which are similar to that in the accounting servers 450 and 550 in the second embodiment.

In this case, the cable television system 100 may be operated to have the non-subscriber station devices 400 and 500 change the recording method of recording the delivery historical information in accordance with the contents delivery situation.

The CPU 240 of the notebook-sized personal computer of the CATV mobile terminal device 200 may comprise instruction information inputting means for inputting recording method instruction information to instruct the non-subscriber station device 400 on the recording method of recording the delivery historical information as similar to that of the second embodiment of the CPU 240 of the notebook-sized personal computer. The accounting servers 450 and 550 of the non-subscriber station devices 400 and 500 may be adapted to record the delivery historical information in accordance with the recording method instruction information inputted by the CPU 240 of the notebook-sized personal computer of the CATV mobile terminal device 200 as similar to that of the second embodiment of the accounting servers 450 and 550.

In this case, the cable television system 100 can be operated to allow the user of the CATV mobile terminal device 200 to specify the recording method of recording the delivery historical information for the non-subscriber station devices 400 and 500, and then to have the non-subscriber station devices 400 and 500 record the delivery historical information thereon by the recording method which is specified by the user of the CATV mobile terminal device 200.

Although the non-subscriber station devices 400 and 500 can be, in each of the aforesaid embodiments, operated to provide several times the services for delivering the contents to the CATV mobile terminal device 200 once the user of the CATV mobile terminal device 200 is authenticated, the non-subscriber station devices 400 and 500 may be adapted to perform the authentication process of authenticating the user of the CATV mobile terminal device 200 whenever the CATV mobile terminal device 200 are provided with the service for delivering the contents.

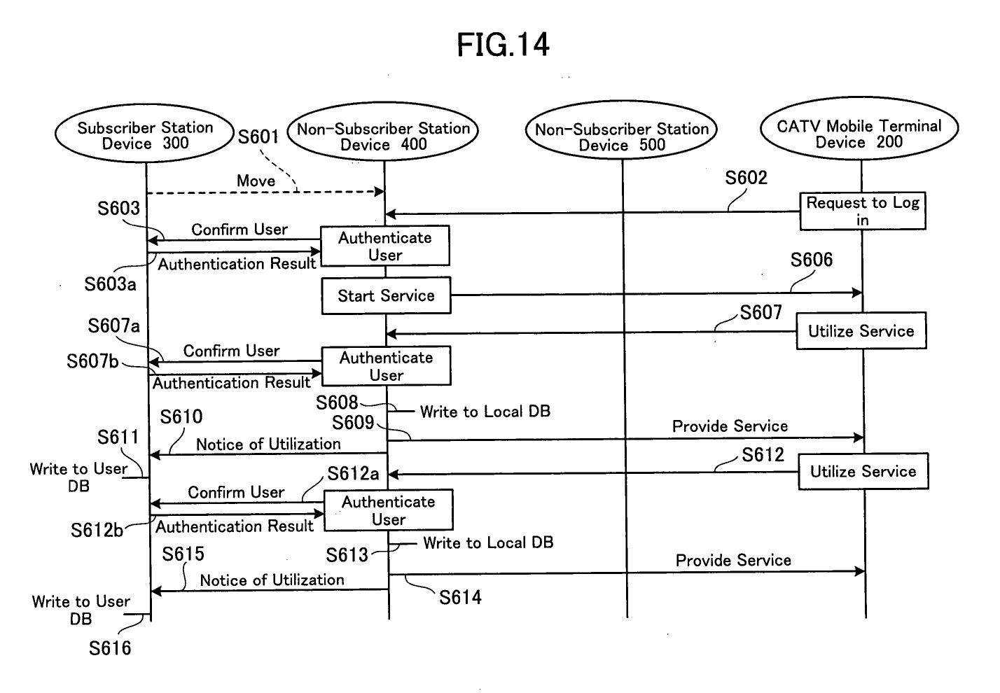

For example, the non-subscriber station device 400 in the first embodiment may perform the process shown in FIG. 14 instead of the process shown in FIG. 3. In FIG. 14, the non-subscriber station device 400 is operated to judge that the user of the CATV mobile terminal device 200 is authenticated by the authentication server 320 on the basis of the result of the authentication process transmitted by the accounting server 320 of the subscriber station device 300, in the step S603a. Thereafter, the non-subscriber station device 400 may be then operated to perform the authentication process of authenticating the user of the CATV mobile terminal device 200 in the steps S607a, S607b, S612a, and 612b, whenever the notice is received from the CATV mobile terminal device 200 but the registered authentication information which is stored by the authentication server 320 is not stored therein, in the steps S607 and S612.

Because the authentication process of authenticating the user of the CATV mobile terminal device 200 is performed whenever the CATV mobile terminal device 200 are provided with the services for delivering the contents, the non-subscriber station devices 400 and 500 can therefore improve reliability in the authentication process of authenticating the user of the CATV mobile terminal device 200 in comparison with that in the case where the CATV mobile terminal device 200 can be provided with the services for delivering the contents several times once the user of the CATV mobile terminal device 200 is authenticated.

It will be apparent from the previously mentioned description that the present invention can provide a cable television system, a contents delivering device, an accounting device, a wireless terminal device, and a method of providing a cable television service by wireless wherein the non-subscriber station device can provide the cable television service for the wireless terminal device.

1. A cable television system comprising:
a plurality of contents delivering devices each having delivering means for delivering contents concerning a cable television service;
a wireless terminal device having wireless connection means for connecting to either one of said plural contents delivering devices by wireless; and
an accounting device having accounting means for performing an accounting process, wherein
each of said contents delivering devices further including:
delivery history storing means for acquiring a delivery historical file having a set of delivery historical information representative of a history of delivering said contents from the other contents delivering devices which have been just before connected to said wireless terminal device by said wireless connection means to store the acquired delivery historical file therein when said contents delivering device is connected to said wireless terminal device by said wireless connection means; and
delivery history recording means for recording said delivery historical information on said delivery historical file stored by said delivery history storing means when said contents are delivered to said wireless terminal device, which is connected by said wireless connection means, by said delivering means,
said accounting device being operated to have said accounting means perform said accounting process on the basis of said delivery historical information in said delivery historical file stored by said delivery history storing means.

2. A cable television system as set forth in claim 1, wherein said wireless terminal device includes:
delivery receipt history storing means for storing a delivery receipt historical file having a set of delivery receipt historical information representative of a history of receiving said delivered contents; and
delivery receipt history recording means for recording said delivery receipt historical information on said delivery receipt historical file stored by said delivery receipt history storing means when said contents are delivered by said delivering means of said contents delivering device which is connected to said wireless terminal device by said wireless connection means,
said accounting device including matching means for matching between said histories concerning the delivered contents on the basis of said delivery historical information used by said accounting means and said delivery receipt historical information of said delivery receipt historical file stored by said delivery receipt history storing means.

3. A cable television system as set forth in claim 1 or 2, wherein said accounting device has:
connection information acquiring means for acquiring connected device information representative of which of said contents delivering devices is connected to said wireless terminal device by said wireless connection means; and
last connected device judging means for judging which of said contents delivering devices was connected last to said wireless terminal device by said wireless connection means on the basis of said connected device information acquired by said connection information acquiring means, wherein
said accounting device is operated to have said accounting means perform said accounting process on the basis of said delivery historical information of said delivery historical file stored by said delivery history storing means of said contents delivering device which is judged by said last connected device judging means.

4. A cable television system comprising:
a plurality of contents delivering devices each having delivering means for delivering contents concerning a cable television service;
a wireless terminal device having wireless connection means for connecting to either one of said plural contents delivering devices by wireless; and
an accounting device having accounting means for performing an accounting process, wherein
each of said contents delivering devices further including:
delivery history storing means for storing therein a delivery historical file having a set of delivery historical information representative of a history of delivering said contents; and
delivery history recording means for recording said delivery historical information on said delivery historical file stored by said delivery history storing means when said contents are delivered by said delivering means to said wireless terminal device which is connected by said wireless connection means,
said accounting device having history accumulating means for accumulating said delivery historical information of said plural delivery historical file stored by said delivery history storing means of said plural contents delivering devices, and being operated to have said accounting means perform said accounting process on the basis of said delivery historical information accumulated by said history accumulating means.

5. A cable television system as set forth in claim 4, wherein said wireless terminal device includes:
delivery receipt history storing means for storing a delivery receipt historical file having a set of delivery receipt historical information representative of a history of receiving said delivered contents; and
delivery receipt history recording means for recording said delivery receipt historical information on said delivery receipt historical file stored by said delivery receipt history storing means when said contents are delivered by said delivering means of said contents delivering device which is connected to said wireless terminal device by said wireless connection means,
said accounting device including matching means for matching between said histories concerning the delivered contents on the basis of said delivery historical information accumulated by said history accumulating means and said delivery receipt historical information of said delivery receipt historical file stored by said delivery receipt history storing means.

6. A cable system as set forth in claim 2 or 5, wherein said accounting device has error information transmitting means for transmitting said history error information indicative that there is an error in said histories concerning said contents delivery to said wireless terminal device when the judgment is made, by said matching means, that said histories concerning said contents delivery are unmatched with each other.

7. A cable television system as set forth in claim 4 or 5, wherein
said accounting device has connection information acquiring means for acquiring connected device information representative of which of said contents delivering devices is connected to said wireless terminal device by said wireless connection means, and
said contents delivering device having:
alteration protecting means for protecting, against an alteration, said delivery historical information of said delivery historical file stored by said delivery history storing means;
last connected device judging means for judging which another one of said contents delivering devices was connected last to said wireless terminal device by said wireless connection means on the basis of said connected device information acquired by said connection information acquiring means; and
instruction information transmitting means for transmitting start instruction information, which instructs the start of operation, to said alteration protecting means of said another contents delivering device judged by said last connected device judging means, and
said contents delivering device being operated to have said alteration protecting means protect, against the alteration, said delivery historical information of said delivery historical file stored by said delivery history storing means when said start instruction information is transmitted by said instruction information transmitting means of the other contents delivering device.

8. A cable television system as set forth in any of claims 1 through 6, wherein said contents delivering device includes alteration protecting means for protecting, against an alteration, said delivery historical information of said delivery historical file stored by said delivery history storing means when the connection with said wireless terminal device is halted by said wireless connection means.

9. A cable television system as set forth in any of claims 1 through 8, wherein contents delivering device is operated to have said delivery history recording means record said delivery historical information in accordance with a contents delivery situation indicative how said contents are delivered from said delivering means to said wireless terminal device connected by said wireless connection means.

10. A cable television system as set forth in any of claims 1 through 8, wherein
said wireless terminal device has instruction information inputting means for inputting a recording method instructing information for instructing a recording method of recording said delivery historical information to said contents delivering device, and
said contents delivering device being operated to have said delivery history recording means record said delivery historical information in accordance with said recording method instructing information inputted by said instruction information inputting means.

11. A cable television system comprising:
a contents delivering device having delivering means for delivering contents concerning a cable television service;
a wireless terminal device having wireless connection means for connecting to said contents delivering device by wireless; and
an authentication information registration device having registered information storing means for storing therein a registered authentication information previously registered for an authentication process, wherein
said wireless terminal device has authentication information transmitting means for transmitting, to said contents delivering device which is connected by said wireless connection means, input authentication information inputted for said authentication process,
said contents delivering device having:
acquired information storing means for acquiring said registered authentication information stored by said registered information storing means to store the acquired registered authentication information therein;
acquired information authentication means for perform said authentication process of authenticating a user of said wireless terminal device on the basis of said input authentication information transmitted by said authentication information transmitting means and said registered authentication information stored by said acquired information storing means; and
delivery permitting means for permitting said delivering means to deliver said contents to said wireless terminal device connected by said wireless connection means when said user of said wireless terminal device is authenticated by said acquired information authentication means.

12. A cable television system as set forth in claim 11, wherein
said contents delivering device has authentication information transferring means for transferring said input authentication information transmitted by said authentication information transmitting means to said authentication information registration device,
said authentication information registration device having transfer information authentication means for performing said authentication process of authenticating the user of said wireless terminal device on the basis of said input authentication information transmitted by said authentication information transferring means and said registered authentication information stored by said registered information storing means, and
said contents delivering device being operated to have said acquired information storing means acquire and store therein said registered authentication information stored by said registered information storing means and store therein the acquired registered authentication information when said user of said wireless terminal device is authenticated by said transfer information authentication means.

13. A cable television system as set forth in claim 12, wherein said authentication information transferring means is operated to transfer said input authentication information to said authentication information registration device on the basis of said input authentication information transmitted by said authentication information transmitting means.

14. A cable television system as set forth in claim 12 or 13, wherein said authentication information registration device is operated to transmit the result of said authentication process to said contents delivering device only when the user of said wireless terminal device is authenticated by said transfer information authentication means.

15. A cable television system as set forth in any of claims 11 though 14, wherein said contents delivering device is operated to have said acquired information storing means record said registered authentication information for a predetermined duration.

16. A cable television system as set forth in any of claims 11 through 15, wherein at least a part of said input authentication information is recorded on a record medium, and said wireless terminal device being operated to receive said input authentication information recorded on said record medium.

17. A contents delivering device comprising:
delivering means for delivering a contents concerning a cable television service;
delivery history storing means for acquiring a delivery historical file having a set of delivery historical information representative of a history of delivering said contents from another contents delivering device which has been just before connected to a wireless terminal device by wireless and to then store the acquired delivery historical file therein when said contents delivering device is connected to said wireless terminal device by wireless; and
delivery history recording means for recording said delivery historical information on said delivery historical file stored by said delivery history storing means when said contents are delivered, by said delivering means, to said wireless terminal device which is connected by wireless.

18. A contents delivering device comprising:
delivering means for delivering a contents concerning a cable television service;
delivery history storing means for acquiring a delivery historical file having a set of delivery historical information representative of a history of delivering said contents to a wireless terminal device connected by wireless by said delivering means; and
delivery history recording means for recording said delivery historical information on said delivery historical file stored by said delivery history storing means when said contents are delivered, by said delivering means, to said wireless terminal device which is connected by wireless.

19. A contents delivering device as set forth in claim 18, further comprising:
alteration protecting means for protecting, against an alteration, said delivery historical information of said delivery historical file stored by said delivery history storing means;
last connected device judging means for judging which another one of said contents delivering devices was connected last to said wireless terminal device by wireless when said contents delivering device is connected to said wireless terminal device by wireless; and
instruction information transmitting means for transmitting start instruction information to said another contents delivering device judged by said last connected device judging means, and
said contents delivering device being operated to have said alteration protecting means protect, against the alteration, said delivery historical information of said delivery historical file stored by said delivery history storing means when said start instruction information is transmitted to said alteration protecting means by the other contents delivering devices.

20. A contents delivering device as set forth in claim 18, further comprising alteration protecting means for protecting, against an alteration, said delivery historical information of said delivery historical file stored by said delivery history storing means when the wireless connection with said wireless terminal device is halted.

21. A contents delivering device as set forth in any of claims 17 through 20, being operated to have said delivery history recording means record said delivery historical information in accordance with a contents delivery situation indicative how said contents are delivered from said delivering means to said wireless terminal device connected by wireless.

22. A contents delivering device as set forth in any of claims 17 through 20, being operated to have said delivery history recording means record said delivery historical information in accordance with said recording method instructing information which is inputted by instruction information inputting means so as to instruct a recording method of recording said delivery historical information and transmitted from said wireless terminal device.

23. A contents delivering device comprising:
delivering means for delivering contents concerning a cable television service to a wireless terminal device connected by wireless;
acquired information storing means for acquiring, from an authentication information registration device, a registered authentication information which is previously registered and stored in said authentication information registration device for an authentication process and to then store the acquired registered authentication information therein;
acquired information authentication means for perform said authentication process of authenticating a user of said wireless terminal device on the basis of: input authentication information transmitted from said wireless terminal device which is inputted to said wireless terminal device for said authentication process; and said registered authentication information stored by said acquired information storing means; and
delivery permitting means for permitting said delivering means to deliver said contents to said wireless terminal device connected by wireless when said user of said wireless terminal device is authenticated by said acquired information authentication means.

24. A contents delivering device as set forth in claim 23, comprising authentication information transferring means for transferring, to said authentication information registration device, said input authentication information transmitted from said wireless terminal device,
said authentication information registration device being operated to perform said authentication process of authenticating the user of said wireless terminal device on the basis of said input authentication information transmitted by said authentication information transferring means and said stored registered authentication information, and
said contents delivering device being operated to have said acquired information storing means acquire said registered authentication information stored by said authentication information registration device and to then store therein the acquired registered authentication information when said user of said wireless terminal device is authenticated.

25. A contents delivering device as set forth in claim 24, wherein said authentication information transferring means is operated to transfer said input authentication information to said authentication information registration device on the basis of said input authentication information transmitted from said wireless terminal device.

26. A contents delivering device as set forth in any of claims 23 through 25, being operated to have said acquired information storing means record said registered authentication information for a predetermined duration.

27. An accounting device comprising accounting means for performing an accounting process on the basis of a set of delivery historical information representative of a history of delivering contents from a contents delivering device to a wireless terminal device which is connected to said contents delivering device by wireless, and said delivery historical information being stored in a delivery historical file by a plurality of said contents delivering devices.

28. An accounting device as set forth in claim 27, comprising matching means for matching between histories concerning the delivered contents on the basis of: said delivery historical information used by said accounting means; and delivery receipt historical information representative of a history of receiving said delivered contents, and a set of said delivery receipt historical information being stored in a delivery receipt historical file by said wireless terminal device.

29. An accounting device as set forth in claim 27 or 28, comprising:
connection information acquiring means for acquiring connected device information representative of which of said contents delivering devices is connected to said wireless terminal device by wireless; and
last connected device judging means for judging which of said contents delivering devices was connected last to said wireless terminal device by wireless on the basis of said connected device information acquired by said connection information acquiring means,
said accounting device having said accounting means perform said accounting process on the basis of said delivery historical information of said delivery historical file stored by said delivery history storing means of said contents delivering device which is judged by said last connected device judging means.

30. An accounting device comprising:
history accumulating means for accumulating a set of delivery historical information representative of a history of delivering contents from a contents delivering device to a wireless terminal device which is connected to said contents delivering device by wireless, and a set of said delivery historical information being stored in a plurality of delivery historical files by a plurality of said contents delivering devices, respectively; and
accounting means for performing an accounting process on the basis of said delivery historical information accumulated by said history accumulating means.

31. An accounting device as set forth in claim 30, comprising matching means for matching between histories concerning the delivered contents on the basis of: said delivery historical information accumulated by said history accumulating means; and delivery receipt historical information representative of a history of receiving said delivered contents, and a set of said delivery receipt historical information being stored in a delivery receipt historical file by said wireless terminal device which is connected to said contents delivering device by wireless.

32. An accounting device as set forth in claim 28 or 31, comprising error information transmitting means for transmitting a history error information indicative that said histories concerning said contents delivery have an error when the judgment is made, by said matching means, that said histories concerning said contents delivery are unmatched with each other.

33. A wireless terminal device comprising:
wireless connection means for connecting by wireless to said contents delivering device which is adapted to deliver contents concerning a cable television service; and
instruction information inputting means for inputting a recording method instructing information to instruct, to said contents delivering device, a recording method of recording a delivery historical information representative of a history of delivering said contents to said contents delivering device.

34. (Cancelled)

35. A method of providing a cable television service by wireless, comprising:
a wireless connecting step of allowing a wireless terminal device to connect, by wireless, to any of a plurality of contents delivering devices which is adapted to deliver contents concerning a cable television service;
a delivering step of allowing said contents delivering device to deliver said contents to said wireless terminal device connected in said wireless connecting step;
a delivery history storing step of allowing said contents delivering device to acquire a delivery historical file having a set of delivery historical information representative of a history of delivering said contents from another contents delivering device which has been just before connected to said wireless terminal device in said wireless connecting step, to then store the acquired delivery historical file therein when said contents delivering device is connected to said wireless terminal device in said wireless connecting step;
a delivery history recording step of allowing said contents delivering device to record said delivery historical information on said delivery historical file stored in said delivery history storing step when said contents are delivered, in said delivering step, to said wireless terminal device which is connected in said wireless connecting step; and
an accounting step of allowing an accounting device to perform an accounting process on the basis of said delivery historical information of said delivery historical file stored in said delivery history storing step.

36. A method of providing a cable television service by wireless, comprising:
a wireless connecting step of allowing a wireless terminal device to connect, by wireless, to any of a plurality of contents delivering devices which is adapted to deliver contents concerning a cable television service;
a delivering step of allowing said contents delivering device to deliver said contents to said wireless terminal device connected in said wireless connecting step;
a delivery history storing step of allowing said contents delivering device to store therein a delivery historical file having a set of delivery historical information representative of a history of delivering said contents;
a delivery history recording step of allowing said contents delivering device to record said delivery historical information on said delivery historical file stored in said delivery history storing step when said contents are delivered in said delivering step to said wireless terminal device which is connected in said wireless connecting step;
history accumulating step of allowing an accounting device to accumulate said delivery historical information of a plurality of said delivery historical files stored by a plurality of said contents delivering devices, respectively, in said delivery history storing step; and
an accounting step of allowing said accounting device to perform an accounting process on the basis of said delivery historical information accumulated in said history accumulating step.

37. A method of providing a cable television service by wireless, comprising:
a wireless connecting step of allowing a wireless terminal device to connect, by wireless, to any of a plurality of contents delivering devices which is adapted to deliver contents concerning a cable television service;
a delivering step of allowing said contents delivering device to deliver said contents to said wireless terminal device connected in said wireless connecting step;
a registered information storing step of allowing an authentication information registration device to store therein a registered authentication information previously registered for an authentication process;
an authentication information transmitting step of allowing said wireless terminal device to transmit, to said contents delivering device which is connected in said wireless connecting step, input authentication information inputted for said authentication process;
an acquired information storing step of allowing said contents delivering device to acquire said registered authentication information stored in said registered information storing step, to then store the acquired registered authentication information therein;
an acquired information authentication step of allowing said contents delivering device to perform said authentication process of authenticating a user of said wireless terminal device on the basis of said input authentication information transmitted in said authentication transmitting step and said registered authentication information stored in said acquired information storing step; and
a delivery permitting step of allowing said contents delivering device to permit delivering said contents to said wireless terminal device connected in said wireless connecting step when said user of said wireless terminal device is authenticated in said acquired information authentication step.
